(19) United States
(12) Patent Application Publication
(10) Pub. No.: US 2025/0245773 A1
(43) Pub. Date: Jul. 31, 2025

(54) Using Steganographic Watermarking to Prevent Deepfakes

(71) Applicant: Cisco Technology, Inc., San Jose, CA (US)

(72) Inventors: M. David HANES, Lewisville, NC (US); Vivek Kumar SINGH, Cary, NC (US); David C. WHITE, JR., St. Petersburg, FL (US)

(21) Appl. No.: 18/422,852

(22) Filed: Jan. 25, 2024

(51) Int. Cl. G06T 1/00; G06T 9/00

(52) U.S. Cl. CPC G06T 1/0064; G06T 9/00

(57) ABSTRACT

Techniques for utilizing invisible and/or inaudible watermarking techniques in media streams (e.g., video and/or audio streams) as a form of in-band steganography to authenticate the source capture camera and/or microphone to prevent deepfakes in network-based communication systems. User device(s) may establish cloud-based connections to a network-based communication system hosting media stream(s). An encoder of a watermarking component of a user device may receive video/audio data directly from a camera/microphone thereof and encode the video/audio data with watermark(s) representing a signed signature. A decoder of a watermarking component of a recipient user device and/or another device associated with the communication system may extract the watermarks and authenticate the signed signature using public certificate(s) associated with the sending user device to validate authenticity of the capture source(s) of the sending user device and that the video/audio data has not been modified since the time of capture.

### TECHNICAL FIELD

The present disclosure relates generally to utilizing invisible and/or inaudible watermarking techniques in media streams (e.g., video and/or audio streams) as a form of in-band steganography to authenticate the source capture camera and/or microphone to prevent deepfakes in network-based communication systems.

### BACKGROUND

Deepfake technology has rapidly evolved over recent years, primarily driven by advancements in machine learning, particularly deep learning techniques. Traditional methods of creating digital content, such as computer graphics and animation, often require significant time and resources to produce realistic results. However, deepfake technology leverages neural networks and sophisticated algorithms to generate highly convincing fake content in a fraction of the time. Additionally, such deepfake technologies may be applied in real-time (e.g., during a live video chat). While the capabilities of deepfake technology have expanded, several challenges and limitations persist, particularly concerning real-time applications. Real-time deepfakes require generating and rendering content instantaneously or with minimal latency, which poses significant computational and technical challenges. As the technology continues to rapidly progress, it gets harder and harder to detect real-time deepfakes. Deepfake detection algorithms are available, but they are just one tool to help prevent deepfakes.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an example environment and flow for a computing resource network hosting a network-based communication system to validate the authenticity of capture source(s) of a broadcasting device streaming video and/or audio data to one or more recipient devices over a media stream.

FIG. 2 illustrates a system-architecture diagram of an example environment and flow for a computing resource network hosting a network-based communication system to validate the authenticity of capture source(s) of a first user device and/or a second user device transmitting video and/or audio data in association with a media stream.

FIG. 3 illustrates a diagram of an example mapping of binary and/or hex data representing a signed signature associated with a user device to watermark symbols that are encoded into video data and representative of the signed signature.

FIG. 4 illustrates a diagram of an example diagram for encoding original images captured by a camera with steganographic watermarks embedded in the images of frames of a video stream.

FIG. 5 illustrates a flow diagram of an example method for a user device to encode invisible watermarks into video data captured by a camera of the user device according to the techniques described herein.

FIG. 6 illustrates a flow diagram of an example method for a network-based communication system to decode invisible watermarks from video data captured by a camera of the user device to validate the authenticity of the camera of the user device according to the techniques described herein.

FIG. 7 illustrates a flow diagram of an example method for a first user device to decode invisible watermarks from video data captured by a camera of a second user device to validate the authenticity of the camera of the second user device according to the techniques described herein.

FIG. 8 illustrates a block diagram illustrating an example packet switching system that can be utilized to implement various aspects of the technologies disclosed herein.

FIG. 9 illustrates a block diagram illustrating certain components of an example node that can be utilized to implement various aspects of the technologies disclosed herein.

FIG. 10 illustrates a computing system diagram illustrating a configuration for a data center that can be utilized to implement aspects of the technologies disclosed herein.

FIG. 11 is a computer architecture diagram showing an illustrative computer hardware architecture for implementing a server device that can be utilized to implement aspects of the various technologies presented herein.

### DESCRIPTION OF EXAMPLE EMBODIMENTS

### Overview

This disclosure describes method(s) for utilizing invisible and/or inaudible watermarking techniques in media streams (e.g., video and/or audio streams) as a form of in-band steganography to authenticate the source capture camera and/or microphone to prevent deepfakes in network-based communication systems. The method includes receiving, at a watermarking component of a first device associated with a network-based communication system, first video data captured by a first camera of the first device in association with a media stream of the network-based communication system. Additionally, or alternatively, the method includes determining a first pattern associated with the first device. Additionally, or alternatively, the method includes determining a first certificate associated with the first camera of the first device. Additionally, or alternatively, the method includes generating a first encoded pattern based at least in part on the first certificate and the first pattern. Additionally, or alternatively, the method includes generating, by the watermarking component, first encoded video data comprising one or more first invisible watermarks overlayed on one or more frames of the first video data. In some examples, the one or more first invisible watermarks may represent at least the first encoded pattern. Additionally, or alternatively, the method includes sending the first encoded video data to a second device associated with the media stream of the network-based communication system.

Additionally, or alternatively, the method includes receiving, from a first device associated with a media stream of the network-based communication system, first video data captured by a first camera of the first device, the first video data being encoded with a first invisible watermark. Additionally, or alternatively, the method includes determining a first encoded pattern represented by the first invisible watermark based at least in part on decoding the first invisible watermark from the first video data. Additionally, or alternatively, the method includes determining a first certificate associated with the first device. Additionally, or alternatively, the method includes determining that the first video data is unmodified since being captured by the first camera of the first device based at least in part on validating the first encoded pattern using the first certificate. Additionally, or alternatively, the method includes providing the first video data to at least a second user device associated with the media stream. Additionally, or alternatively, the method includes sending a signal to at least the second device based at least in part on determining that the first video data is unmodified. In some examples, the signal may cause at least the second device to display an icon while the first video data is being output. Additionally, or alternatively, the icon may indicate that the first video data is unmodified since being captured by the first camera of the first device.

Additionally, or alternatively, the method includes receiving, at a watermark component of a first device and from a media stream associated with a network-based communication system, first video data captured by a first camera of a second device associated with the media stream. In some examples, the first video data may be encoded with a first invisible watermark. Additionally, or alternatively, the method includes determining a first encoded pattern represented by the first invisible watermark based at least in part on decoding the first invisible watermark from the first video data. Additionally, or alternatively, the method includes determining a first certificate associated with the second device. Additionally, or alternatively, the method includes determining that the first video data is unmodified since being captured by the first camera of the second device based at least in part on validating the first encoded pattern using the first certificate. Additionally, or alternatively, the method includes causing the first device to display the first video data and an icon indicating that the first video data is unmodified since being captured by the first camera of the second device based at least in part on determining that the first video data is unmodified.

Additionally, the techniques described herein may be performed by a system and/or device having non-transitory computer-readable media storing computer-executable instructions that, when executed by one or more processors, performs the method described above.

### Example Embodiments

As previously described, the capabilities of deepfake technology have rapidly evolved to the point where such deepfake technologies may be applied in real-time applications. While there are some deepfake detection algorithms available, they may not be viable in real-time environments such as video conferencing scenarios where deepfakes are generated and rendered instantaneously or with minimal latency. This disclosure describes techniques for utilizing invisible and/or inaudible watermarking techniques in media streams (e.g., video and/or audio streams) as a form of in-band steganography to authenticate the source capture camera and/or microphone to prevent deepfakes in network-based communication systems. In some examples, device(s) (e.g., user devices, servers, and/or the like) associated with a network-based communication system (e.g., hosted utilizing a computing resource network, a cloud-computing network, a managed computing network, etc.) may be configured with one or more watermarking components configured to encode captured media (e.g., image, video, and/or audio data) with one or more invisible and/or inaudible steganographic watermarks, decode one or more invisible and/or inaudible steganographic watermarks from encoded media, validate an encoded pattern represented by the watermark(s) using one or more certificate(s) associated with devices engaging in a media stream of the network-based communication system, verify authenticity of the capture source (e.g., microphone and/or camera) from which the captured media originated, and/or transmit video, image, and/or audio data between endpoint devices via respective media stream(s), encrypted end-to-end. By leveraging invisible and/or inaudible watermarks in conjunction with the secure exchange of endpoint verification information in this way, the network-based communication system described herein may be utilized to facilitate the real-time detection of deepfakes.

The watermarking components described herein may be configured with the latest artificial intelligence (AI) watermarking technologies that leverage neural networks. For example, a watermarking component may include an encoder and/or a decoder. In some examples, the encoder may be configured as a first neural network which takes the original image and/or audio data that was captured by the capture source (e.g., a camera and/or microphone) and produces an encoded image that looks visibly identical. In some examples, the encoded image may differ from the original image by slightly modifying some of the pixels, creating an embedded pattern that is invisible to the human eye (or inaudible to the human car in the case of inaudible watermarks encoded into audio data). Additionally, or alternatively, the encoder may be configured to vary the invisible watermarks in the media (e.g., in the images that comprise a video stream), allowing for the in-band, steganographic encoding of binary and/or hex data into the media. This data may then be leveraged to represent a signed or encoded pattern and/or a public certificate for the capture device (e.g., the camera or the microphone). Additionally, or alternatively, the decoder of a watermarking component may be configured as a second neural network configured to spot the embedded pattern that was encoded into the media by the encoder. In some examples, the decoder may detect the pattern and verify whether it detects a watermark, suspects that the media contains a watermark, and/or finds that the media contains no watermark. By leveraging the AI-based watermarking technologies, watermarks encoded in this way cannot be removed from the encoded media and they are not visible to the human eye. Additionally, such watermarks encoded in this way are configured to survive packet loss, resizing, and/or re-encoding, meaning that the encoded watermarks can still be detected even if the media is screenshotted or edited, such as, for example, rotating or resizing of the image (e.g., rotating or cropping an image to resize the media for display on various recipient user device(s)).

The watermarking components may be configured to leverage various device information associated with capture source of media being streamed to verify watermarks encoded in the media. In some examples, public certificate(s) (e.g., a public key) associated with camera(s) and/or microphone(s) of an endpoint device (e.g., a user device) may be leveraged to validate and/or authenticate the watermarks encoded therein. Such public certificates may be encoded directly into the media being streamed and/or transmitted to the network-based communication system at the time the endpoint device registers with the network-based communication system. For example, when an endpoint device connects to the network-based communication system, the network-based communication system may collect registration information associated with the endpoint device, such as, for example, a serial number of the endpoint device, a process identifier (PID) associated with the endpoint device, one or more public certificates associated with the endpoint device, and/or the like. Additionally, or alternatively, a user device and/or server associated with the network-based communication system may comprise a certificate datastore configured to store the certificates associated with capture sources (e.g., cameras and/or microphones) of the endpoint devices associated with the network-based communication system. For example, when a server hosting a media stream associated with the network-based communication system receives encoded media data from a first endpoint device associated with a media stream, the watermarking component of the server may utilize the registration information associated with the first endpoint device to perform a lookup and obtain the public certificates of the camera and/or microphone of the first endpoint device. Additionally, or alternatively, the endpoint device may be configured to encode the public certificate(s) into the media (alongside the watermarks) and the watermarking component may be configured to identify and decode the public certificate(s) from the media. The decoder of a watermarking component may then leverage the public certificate(s) to validate the encoded pattern represented by the watermarks in the media, as described in more detail below.

An endpoint device capturing media to be streamed over the encrypted media streams of the network-based communication system may be configured to determine the encoded pattern represented by the steganographic watermarks encoded into the media using information that is private to the endpoint device (e.g., a private key, a secure unique device identifier (SUDI), and/or the like). In some examples, the information that is private to the endpoint device may be utilized to generate an encoded pattern by signing a non-encoded pattern with the information that is private to the endpoint device. In some examples, the non-encoded pattern may be random and/or may be configured by the endpoint user. For example, the non-encoded pattern may be configured as a timestamp representing the capture time of the media. In some examples, the watermarking component of the endpoint device may be configured to sign the pattern (e.g., the timestamp) using the information that is private to the endpoint device (e.g., the private key) to generate the encoded pattern that is ultimately encoded into the media and represented by the steganographic watermarks. By passing along the public certificates associated with the endpoint device at the time of registration and/or by way of encoding the public certificate(s) into the media, the decoder of a recipient watermarking component (on a recipient endpoint device and/or a server facilitating a media stream of the network-based communication system) may be configured to decode the encoded pattern and leverage the public certificate(s) to authenticate the watermarks.

Take, for example, a first user device may be configured with a first watermarking component and may be connected to a media stream hosted by a network-based communication system. In some examples, the media stream may be configured as a multi-party conference stream comprising any number of users 1-N, where N may be any integer greater than 1. Additionally, or alternatively, one or more second user devices associated with the media stream may comprise one or more second watermarking components. The user devices may establish cloud-based connection(s) to the network-based communication system. In some examples, the user devices may be configured to exchange registration information with the network-based communication system at the time the cloud-based connection(s) are established. Additionally, or alternatively, the media stream may be configured to transmit image, audio, and/or video data between user devices associated with the media stream via respective encrypted streams.

The first user of the first device may be configured as a presenter in association with the media stream, such that the first user will be transmitting media to one or more second users associated with the media stream. The media being captured of the first user by the first user device may be authenticated by the network-based communication system, and the network-based communication system may cause the one or more second user devices to display an icon indicating, to respective second users of the second user devices, that the media stream (e.g., the video and audio streams) have been unmodified since the time of capture at the first user device according to the techniques described herein.

For example, the video and/or audio of the first user may be captured by the first user device (e.g., via a camera and/or a microphone associated with the first user device) and sent to the first watermarking component of the first user device. Additionally, or alternatively, private certificate(s) associated with the camera and/or the microphone of the first user device may be transmitted to the first watermarking component of the first user device. In some examples, the private certificate(s) may comprise a private key, an SUDI certificate, and/or the like. That is, the first watermarking component may receive first video data captured by a first camera of the first user device and/or first audio data captured by a first microphone of the first user device in association with the media stream of the network-based communication system.

Once the first watermarking component receives the video data and/or audio data, an encoder of the first watermarking component may be configured to encode the video data and/or audio data with one or more watermark(s). For example, the first user device may generate a pattern used to determine the watermarks. In some examples, parameters for generating the pattern may be configured by the network-based communication system. Additionally, or alternatively, the pattern may be based on a random pattern generation, and/or based on a timestamp representing the time at which the video data and/or audio data was captured. The first watermarking component may be configured to generate an encoded pattern by signing the pattern using the private certificate(s) received from the camera and/or the microphone of the first user device. For example, a first encoded pattern may be generated in association with the video data and based at least in part on signing the pattern with a first private certificate associated with the camera of the first user device. Additionally, or alternatively, a second encoded pattern may be generated in association with the audio data and based at least in part on signing the pattern with the second private certificate associated with the microphone of the first user device. Additionally, or alternatively, a single encoded pattern may be generated in association with both the video data and the audio data based on signing the pattern with both the first private certificate and the second private certificate. Once the encoded pattern(s) are determined, the encoder of the first watermarking component may generate encoded video data and/or encoded audio data based on encoding watermark(s) representing the encoded pattern(s) into the video data and/or audio data. Watermarks encoded into the video data may be steganographic watermarks that are invisible to the human eye and only detectable by a specific neural network (e.g., the decoder of a receiving watermarking component). Additionally, or alternatively, watermarks encoded into the audio data may be steganographic watermarks that are inaudible to the human car and only detectable by a specific neural network (e.g., the decoder of a receiving watermarking component). In some examples, the encoder may be configured to encode both the first encoded pattern associated with the video data and the second encoded pattern associated with the audio data into the encoded video data and sent over the video stream. That is, in some examples, only the video data is encoded with watermarks comprising the encoded patterns utilized to authenticate both the video data and the audio data. By encoding in this way, the watermarks cannot be removed and are not visible to the human eye. Additionally, the watermarks are configured to survive packet loss, resizing, rotation, re-encoding, and/or the like.

The first watermarking component may then be configured to send the encoded video data and/or the encoded audio data over the media stream. For example, the first watermarking component may send the encoded video data to a server associated with the network-based communication system via a first encrypted video stream connecting the first user device to the server. Additionally, or alternatively, the first watermarking component may sent the encoded audio data to the server via a first encrypted audio stream connecting the first user device to the server. That is, a second watermarking component of the server may be configured to receive the video data captured by the first camera of the first user device and/or the audio data captured by the first microphone of the first user device, where the video data and/or audio data are encoded with invisible and/or inaudible watermarks.

The server associated with the network-based communication system may be configured with a second watermarking component and/or a certificate database as described herein. The decoder of the second watermarking component may be configured to extract the invisible watermarks from the video data and/or the audio data to reveal a binary and/or hexadecimal message from the first user device (e.g., the encoded pattern(s)). The server may utilize the registration information associated with the first user device and stored in the certificate database to determine one or more first public certificate(s) (e.g., a public key) associated with the first user device. For example, the server may utilize the serial number and/or PID associated with the first user device to look up a first public certificate associated with the first camera and/or a second public certificate associated with the first microphone. The second watermarking component may then decode the encoded pattern(s) represented by the steganographic watermarks. That is, the second watermarking component may be configured to decode the first encoded pattern associated with the video data and/or decode the second encoded pattern associated with the audio data. The second watermarking component may then validate the authenticity of the camera and/or microphone as capturing the video and/or audio, and that the video and/or audio has not been modified since capture based on a first public certificate associated with the camera of the first user device and/or based on a second public certificate associated with the microphone of the first user device.

Once validated, the server associated with the network-based communication system may then send the video data and/or the audio data to the one or more second user devices associated with the media stream. For example, the server may send the video data via one or more second encrypted video streams and/or the audio data via one or more second encrypted audio stream to respective second user devices associated with the media stream. Additionally, following validation of the authenticity of the capture source camera and/or microphone, the second watermarking component may send a signal to the second user devices indicating that the video and/or audio stream(s) have been unmodified from the time of capture at the source by a validated camera and/or microphone. In some examples, the signal may cause an icon to display on the screens of the second user device(s) indicating the validation of authenticity of the capture source(s). Additionally, or alternatively, the signal may cause the second user devices to output a sound, and/or display any other form of indication that the capture source(s) authenticity has been validated. This process may continuously run as the media stream persists, and if the authenticity of the capture source cannot be validated at any point during the media stream, additional signal(s) may be sent to the second user devices causing the icon (or other indication) to toggle on and/or off as needed.

While the above example is described with respect to a media stream configured as a multi-party conference stream, take, for example, the media stream being configured as a point-to-point stream comprising the first user device configured with the first watermarking component and a second user device configured with a second watermarking component. In such an example, the server associated with the network-based communication system may be configured to host the encrypted video stream(s) and/or encrypted audio stream(s) associated with the media stream, without validating the authenticity of the capture source. Additionally, or alternatively, the second watermarking component of the second user device may be configured to validate the authenticity of the capture source, according to the techniques described herein. For example, during the encoding of the steganographic watermarks into the video data and/or audio data, the first watermarking component of the first user device may be configured to encode the public certificate and/or the encoded pattern(s) generated by the first user device into the video data and/or audio data as watermarks. That is, the public certificate(s) of the camera and/or microphone of the first user device may be first encoded into the video data and/or audio data as first watermark(s) and the encoded pattern(s) may be encoded into the video data and/or audio data as second watermark(s). The first watermarking component may send the encoded video data and/or the encoded audio data via a first encrypted video stream and/or a first encrypted audio stream to the server, and the server may send the encoded video data and/or encoded audio data to the second user device via a second encrypted video stream and/or a second encrypted audio stream. That is, the server may facilitate end-to-end encryption of the media stream between the first user device and the second user device.

The second watermarking component of the second user device may receive the encoded video data and/or encoded audio data and the decoder thereof may extract the invisible and/or inaudible watermarks from the video data and/or audio data. In examples where the public certificate(s) associated with the first user device are encoded into the video data and/or audio data, the second watermarking component may be configured to extract the public certificate(s) from the video and/or audio data and use the public certificate(s) to authenticate the encoded pattern(s) that will be received throughout the remainder of the media stream. Additionally, or alternatively, the server associated with the network-based communication system may be configured to lookup the public certificate(s) associated with the first user device according to techniques described herein, and may send the public certificate(s) to the second user device. The public certificate(s) may be leveraged by the second watermarking component to authenticate the encoded pattern(s) represented by the second watermark(s) so that the second user device may validate the authenticity of the video data and/or audio data received from the first user device. Upon validation, the second user device may display an icon informing the second user of the second device that the video and/or audio stream has been unmodified from the time of capture at the first user device.

While the above examples describe validating the authenticity of video and/or audio captured by a camera and/or microphone of a first user device, the techniques described herein may be implemented on each individual user device associated with a media stream such that all of the capture sources for each of the user devices are validated to be unmodified since the time of capture. Additionally, or alternatively, the techniques described herein may be utilized to capture video and/or audio on a first user device, encoded with watermarks, and sent to a server for storage and/or later broadcast, where the authenticity of the capture source of both the video and/or the audio may be validated and indicated to users that view the media at a later time.

As described herein, a computing-based, network-based, cloud-based solution, network device, can generally include any type of resources implemented by virtualization techniques, such as containers, virtual machines, virtual storage, and so forth. Further, although the techniques described as being implemented in data centers and/or a cloud computing network, the techniques are generally applicable for any network of devices managed by any entity where virtual resources are provisioned. In some instances, the techniques may be performed by a schedulers or orchestrator, and in other examples, various components may be used in a system to perform the techniques described herein. The devices and components by which the techniques are performed herein are a matter of implementation, and the techniques described are not limited to any specific architecture or implementation.

The techniques described herein provide various improvements and efficiencies with respect to detecting deepfakes. For instance, the techniques described herein include encoding video and/or audio data, received directly from the capture source(s), with watermarks determined by signing a pattern with a private key associated with the capture source(s). By encoding watermarks in this way, public certificates associated with the capture source(s) can be leveraged and the watermarks may be decoded from the media such that the capture source(s) can be validated using the public certificates. Additionally, the techniques described herein include encoding steganographic watermarks that are invisible to the human eye and/or inaudible to the human car into video and/or audio data using a specific encoder, and that are detectable using a specific decoder. For instance, the encoder may be configured as a first neural network configured to leverage AI to generate the encoded images that include invisible watermarks represented by hex and/or binary data and/or the decoder may be configured as a second neural network configured to leverage AI to identify the invisible watermarks encoded into the images. By encoding the steganographic watermarks in this way, the watermarks cannot be removed, are invisible to the human eye, inaudible to the human car, survive packet loss, resizing, rotation, and/or re-encoding. This increases security of network-based communication systems, as capture sources may be validated and indicated as such to recipient devices, allowing observers to have confidence that the video they are watching was captured real-time by an image capture and/or audio capture device. That is, network security may be increased as the capture source(s) of endpoints of a media stream are vetted to ensure that a broadcaster is not broadcasting fake media.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

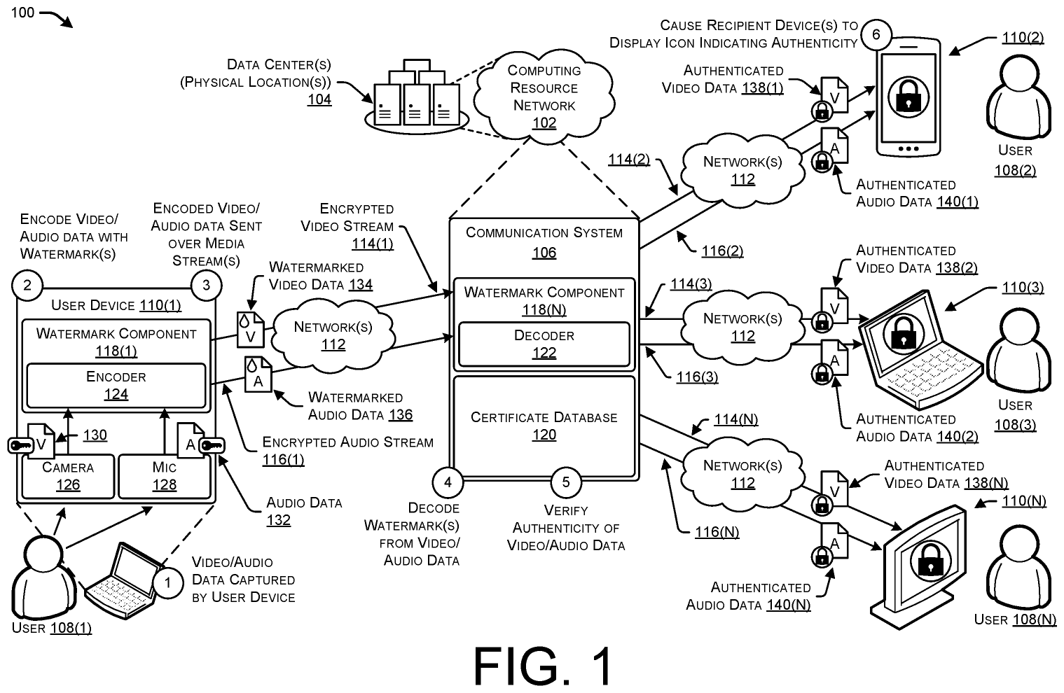

FIG. 1 illustrates a system-architecture diagram of an example environment 100 and flow for a computing resource network 102 hosting a network-based communication system to validate the authenticity of capture source(s) of a broadcasting device streaming video and/or audio data to one or more recipient devices over a media stream. Generally, the computing resource network 102 may include devices that are housed or located in one or more data centers 104 that may be located at different physical locations. For instance, the computing resource network 102 may be supported by networks of devices in a public cloud computing platform, a private/enterprise computing platform, and/or any combination thereof. The one or more data centers 104 may be physical facilities or buildings located across geographic areas that are designated to store networked devices that are part of the computing resource network 102. The data centers 104 may include various networking devices, as well as redundant or backup components and infrastructure for power supply, data communications connections, environmental controls, and various security devices. In some examples, the data centers 104 may include one or more virtual data centers which are a pool or collection of cloud infrastructure resources specifically designed for enterprise needs, and/or for cloud-based service provider needs. Generally, the data centers 104 (physical and/or virtual) may provide basic resources such as processor (CPU), memory (RAM), storage (disk), and networking (bandwidth). However, in some examples the devices in the computing resource network 102 may not be located in explicitly defined data centers 104 and, rather, may be located in other locations or buildings.

The computing resource network 102 may host a network-based communication system 106 that may be accessible to user(s) 108(1)-(N) via user device(s) 110(1)-(N) (also referred to herein as endpoint devices), over one or more network(s) 112, such as the internet, where N may be any integer greater than 1. Additionally, or alternatively, the network-based communication system 106 may provide the user devices 110 network access for hosting media streams that connect the user device(s) 110 and allow for real-time streaming of video data over one or more encrypted video streams 114(1)-(N) and/or audio data over one or more encrypted audio streams 116(1)-(N), where N may be any integer greater than 1. In some examples, the encrypted video streams 114 and/or encrypted audio streams 116 may be encrypted using transport layer security (TLS) and/or datagram transport layer security (DTLS) techniques. The computing resource network 102, the network-based communication system 106, and/or the networks 112, may each respectively include one or more networks implemented by any viable communication technology, such as wired and/or wireless modalities and/or technologies. The computing resource network 102, the network-based communication system 106, and/or the networks 112 may each include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The computing resource network 102 may include devices, virtual resources, or other nodes that relay packets from one network segment to another by nodes in the computer network.

As previously mentioned, the computing resource network 102, may provide, host, or otherwise support a network-based communication system 106 for user devices 110 to connect to and use. The user devices 110 may comprise any device configured to communicate using various protocols (e.g., VPN, SSL, TLS, DTLS, QUIC, IPsec, and/or any other protocol) over the networks 112. In some examples, the user devices 110 may be configured to establish a cloud-based connection with the network-based communication system 106. For instance, the user device 110 may comprise a personal user device (e.g., desktop computers, laptop computers, phones, tablets, wearable devices, entertainment devices such as televisions, etc.), network devices (e.g., servers, routers, switches, access points, etc.), and/or any other type of computing device.

In some examples, the network-based communication system 106 may include a watermarking component 118(N) and/or a certificate database 120. In some examples, the watermarking component 118(N) may include a decoder 122 for decoding media encoded with watermarks, as described herein. Additionally, or alternatively, the user device(s) 110, such as, user device 110(1), for example, may include a watermarking component 118(1) comprising an encoder 124 for encoding media captured by the user device 110(1) with watermarks. Additionally, or alternatively, the user device 110(1) may include a camera 126, a microphone 128, and/or a display.

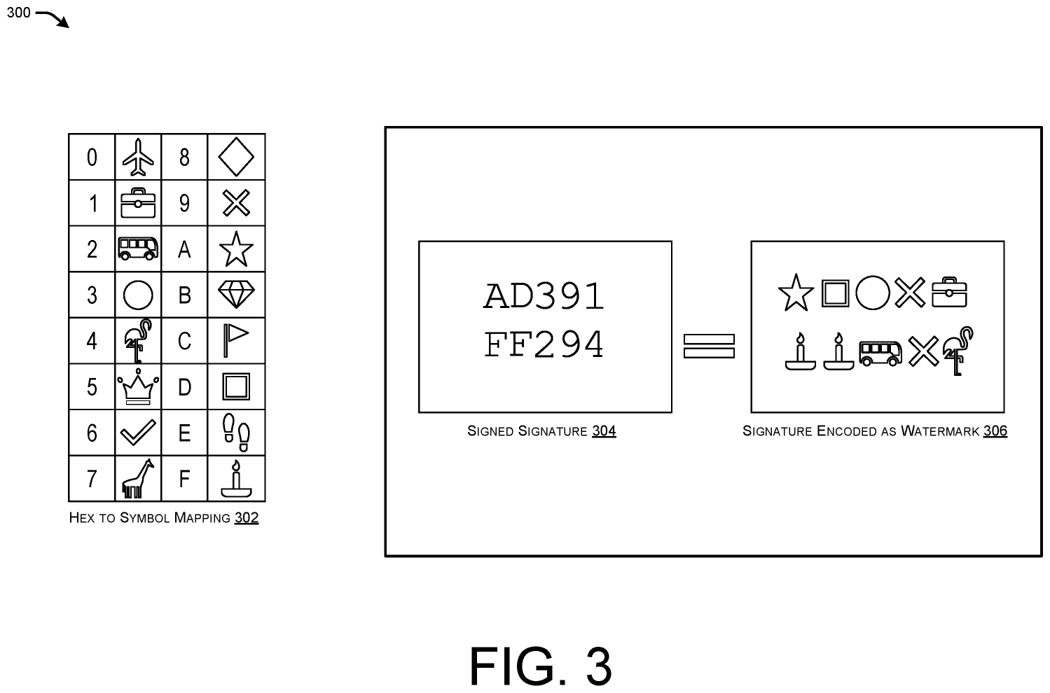

The watermarking component(s) 110 described herein may be configured with the latest artificial intelligence (AI) watermarking technologies that leverage neural networks. For example, a watermarking component 110 may include an encoder 124 and/or a decoder 122. In some examples, the encoder 124 may be configured as a first neural network which takes original video data 130 and/or audio data 132 that was captured by the capture source (e.g., a camera 126 and/or microphone 128) and produces an encoded image (e.g., watermarked video data 134) that looks visibly identical to the original video data 130. In some examples, the watermarked video data 134 may differ from the original video data 130 by slightly modifying some of the pixels and creating an embedded pattern that is invisible to the human eye (or inaudible to the human car in the case of inaudible watermarks encoded into audio data 132 as watermarked audio data 136). Additionally, or alternatively, the encoder 124 may be configured to vary the invisible watermarks in the media (e.g., in the images that comprise a video stream), allowing for the in-band, steganographic encoding of binary and/or hex data into the media, as described in more detail with respect to FIG. 3. This data may then be leveraged to represent a signed or encoded pattern and/or a public certificate associated with the capture device (e.g., the camera 126 or the microphone 128). Additionally, or alternatively, the decoder 122 of a watermarking component 118 may be configured as a second neural network configured to spot the embedded pattern that was encoded into the media by the encoder 124. In some examples, the decoder 122 may detect the pattern and verify whether it detects a watermark, suspects that the media contains a watermark, and/or finds that the media contains no watermark. By leveraging the AI-based watermarking technologies, watermarks encoded in this way cannot be removed from the encoded media 134, 136 and they are not visible to the human eye. Additionally, such watermarks encoded in this way are configured to survive packet loss, resizing, and/or re-encoding, meaning that the encoded watermarks can still be detected even if the media 134, 136 is screenshotted, recorded, or otherwise edited, such as, for example, rotating or resizing of the image (e.g., rotating or cropping an image to resize the media for display on various recipient user device(s) 110(2)-(N)).

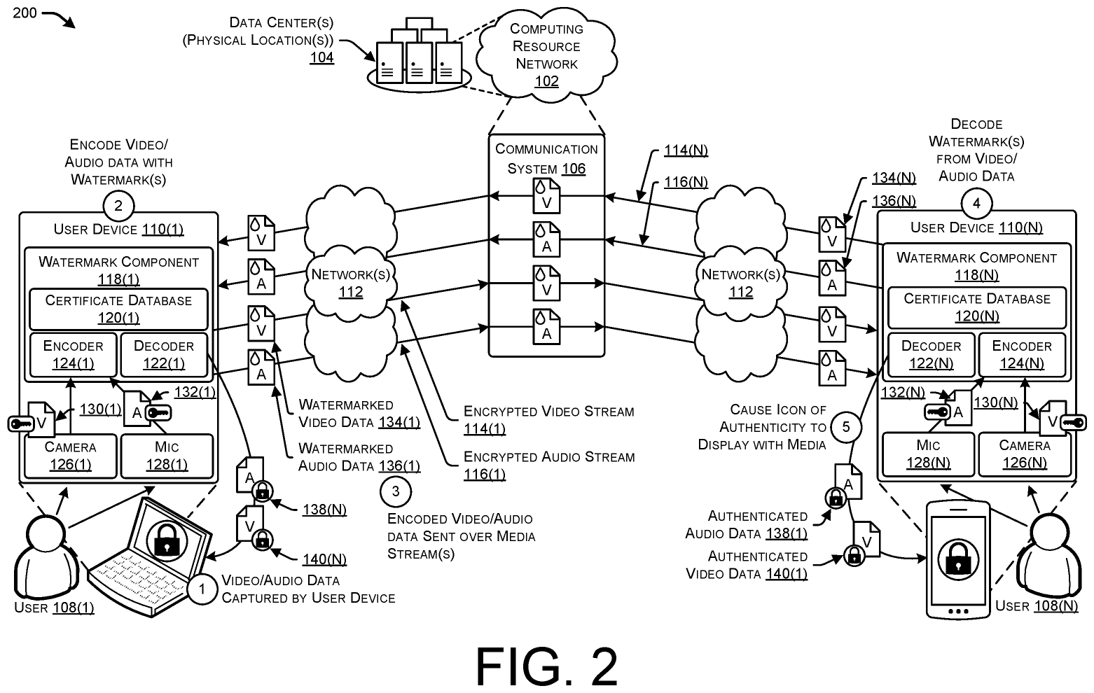

The watermarking components may be configured to leverage various device information associated with capture source (e.g., the camera 126 or the microphone 128) of media being streamed to verify watermarks encoded in the watermarked video data 134 and/or the watermarked audio data 136. In some examples, public certificate(s) (e.g., a public key) associated with camera(s) 126 and/or microphone(s) 128 of an endpoint device 110 (e.g., a user device) may be leveraged to authenticate the watermarks encoded into the watermarked video data 134 and/or the watermarked audio data 136. These certificates are illustrated in FIGS. 1 and 2 as the key icon accompanying the video data 130 and/or audio data 132, respectively. Such public certificates may be encoded directly into the media being streamed and/or transmitted to the network-based communication system 106 at the time the endpoint device 110(1) registers with the network-based communication system 106. For example, when an endpoint device 110(1) connects to the network-based communication system 106, the network-based communication system 106 may collect registration information associated with the endpoint device 110(1), such as, for example, a serial number of the endpoint device 110(1), a process identifier (PID) associated with the endpoint device 110(1), one or more public certificates associated with the endpoint device 110(1), and/or the like. Additionally, or alternatively, a user device 110 and/or server 104 associated with the network-based communication system 106 may comprise a certificate datastore 120 configured to store the certificates associated with capture sources (e.g., cameras 126 and/or microphones 128) of the endpoint devices 110 associated with the network-based communication system 106. For example, when a server 104 hosting a media stream associated with the network-based communication system 106 receives the watermarked video data 134 and/or the watermarked audio data 136 from a first endpoint device 110(1) associated with a media stream, the watermarking component 118(N) of the network-based communication system 106 may utilize the registration information associated with the first endpoint device 110(1) to perform a lookup and obtain the public certificates of the camera 126 and/or microphone 128 of the first endpoint device 110. Additionally, or alternatively, the endpoint device 110 may be configured to encode the public certificate(s) into the video data 130 and/or audio data 132 (alongside the watermarks) and the watermarking component 118(N) may be configured to identify and decode the public certificate(s) from the watermarked video data 134 and/or the watermarked audio data 136. The decoder 122 of a watermarking component 118(N) may then leverage the public certificate(s) in the certificate database 120 to validate the encoded pattern represented by the watermarks in the watermarked video data 134 and/or the watermarked audio data 136, as described in more detail below.

An user device 110(1) capturing video data 130 to be streamed over the encrypted video stream 114(1) and/or audio data 132 to be streamed over the encrypted audio stream 116(1) of the network-based communication system 106 may be configured to determine the encoded pattern represented by the steganographic watermarks in the watermarked video data 134 and/or the watermarked audio data 136 and sign that data using information that is private to the endpoint device 110(1) (e.g., a private key, a secure unique device identifier (SUDI), and/or the like). In some examples, the information that is private to the endpoint device 110(1) may be utilized to encode a non-encoded pattern by signing the non-encoded pattern with the information that is private to the endpoint device 110(1). In some examples, the non-encoded pattern may be random and/or may be configured by the endpoint user 108. For example, the non-encoded pattern may be configured as a timestamp representing the capture time of the video data 130 and/or the audio data 132. In some examples, the watermarking component 118(1) of the endpoint device 110(1) may be configured to sign the pattern (e.g., the timestamp) using the information that is private to the endpoint device 110(1) (e.g., the private key) to generate the encoded pattern that is ultimately encoded into the video data 130 and/or audio data 132 and represented by the steganographic watermarks in the watermarked video data 134 and/or the watermarked audio data 136. By passing along the public certificates associated with the endpoint device 110(1) at the time of registration and/or by way of encoding the public certificate(s) into the media, the decoder 122 of a recipient watermarking component 118(N) (on a recipient endpoint device 110(2)-(N) and/or a server 104 facilitating a media stream of the network-based communication system 106) may be configured to decode the encoded pattern and leverage the public certificate(s) to verify the watermarks in the watermarked video data 134 and/or the watermarked audio data 136.

Take, for example, a first user device 110(1) may be configured with a first watermarking component 118(1) and may be connected to a media stream (comprising the encrypted video streams 114(1)-(N) and/or the encrypted audio streams 116(1)-(N) hosted by a network-based communication system 106. In some examples, the media stream may be configured as a multi-party conference stream comprising any number of user device(s) 110(1)-(N), where N may be any integer greater than 1. Additionally, or alternatively, one or more second user devices 110(2)-(N) associated with the media stream may comprise one or more second watermarking components, as illustrated in FIG. 2. The user devices 110 may establish cloud-based connection(s) to the network-based communication system 106 via the one or more networks 112. In some examples, the user devices 110 may be configured to exchange registration information with the network-based communication system 106 at the time the cloud-based connection(s) are established. Additionally, or alternatively, the media stream(s) may be configured to transmit image data, audio data 132, and/or video data 130 between user devices 110 associated with the media stream via respective encrypted video streams 114(1)-(N) and/or encrypted audio streams 116(1)-(N).

The first user 108(1) of the first device 110(1) may be configured as a presenter in association with the media stream, such that the first user 108(1) will be transmitting media to one or more second users 108(2)-(N) associated with the media stream. The media being captured of the first user 108(1) by the first user device 110(1) may be authenticated by the network-based communication system 106, and the network-based communication system 106 may cause the one or more second user devices 110(2)-(N) to display an icon indicating, to respective second users 108(2)-(N) of the second user devices 110(2)-(N), that the video data 130 and/or the audio data 132 have been unmodified since the time of capture by the camera 126 and/or microphone 128 at the first user device 110(1), according to the techniques described herein. Below is an example flow describing a network-based communication system 106 configured to validate the authenticity of capture source(s) 126, 128 of a broadcasting device 110(1) streaming video data 130 and/or audio data 132 to one or more recipient devices 110(2)-(N) over encrypted video streams 114(1)-(N) and/or encrypted audio streams 116(1)-(N).

At “1,” video data 130 and/or audio data 132 associated with the first user 108(1) may be captured by a camera 126 and/or a microphone 128 of the first user device 110(1) and sent to the first watermarking component 118(1) of the first user device 110(1). Additionally, or alternatively, private certificate(s) associated with the camera 126 and/or the microphone 128 (as illustrated in FIGS. 1 and 2 as the key icon accompanying the video data 130 and/or the audio data 132, respectively) of the first user device 110(1) may be transmitted to the first watermarking component 118(1) of the first user device 110(1). In some examples, the private certificate(s) may comprise a private key, an SUDI certificate, and/or the like. That is, the first watermarking component 118(1) may receive first video data 130 captured by a first camera 126 of the first user device 110(1) and/or first audio data 132 captured by a first microphone 128 of the first user device 110(1) in association with the media stream of the network-based communication system 106.

At “2,” the first watermarking component 118(1) receives the video data 130 and/or audio data 132, an encoder 124 of the first watermarking component 118(1) may be configured to encode the video data 130 and/or audio data 132 with one or more watermark(s). For example, the first user device 110(1) may generate a pattern used to determine the watermarks. In some examples, parameters for generating the pattern may be configured by the network-based communication system 106. Additionally, or alternatively, the pattern may be based on a random pattern generation, and/or based on a timestamp representing the time at which the video data 130 and/or audio data 132 was captured. The first watermarking component 110(1) may be configured to generate an encoded pattern by signing the pattern using the private certificate(s) received from the camera 126 and/or the microphone 128 of the first user device 110(1). For example, a first encoded pattern may be generated in association with the video data 130 and based at least in part on signing the pattern with a first private certificate associated with the camera 126 of the first user device 110(1). Additionally, or alternatively, a second encoded pattern may be generated in association with the audio data 132 and based at least in part on signing the pattern with the second private certificate associated with the microphone 128 of the first user device 110(1). Additionally, or alternatively, a single encoded pattern may be generated in association with both the video data 130 and the audio data 132 based on signing the pattern with both the first private certificate and the second private certificate. Once the encoded pattern(s) are determined, the encoder 124 of the first watermarking component may generate watermarked video data 134 (also referred to herein as encoded video data) and/or watermarked audio data 136 (also referred to herein as encoded audio data) based on encoding watermark(s) representing the encoded pattern(s) into the video data 130 and/or audio data 132. Watermarks encoded into the video data 130 may be steganographic watermarks that are invisible to the human eye and only detectable by a specific neural network (e.g., the decoder 122 of a receiving watermarking component 118(N)). Additionally, or alternatively, watermarks encoded into the audio data 132 may be steganographic watermarks that are inaudible to the human car and only detectable by a specific neural network (e.g., the decoder 122 of a receiving watermarking component 118(N)). In some examples, the encoder 124 may be configured to encode both the first encoded pattern associated with the video data 130 and the second encoded pattern associated with the audio data 132 into the encoded video data 134 and sent over the encrypted video stream 114(1). That is, in some examples, only the video data 130 is encoded with watermarks comprising the encoded patterns utilized to validate the authenticity of both the video data 130 and the audio data 132. By encoding in this way, the watermarks cannot be removed, are not visible to the human eye, and are inaudible to the human car. Additionally, the watermarks are configured to survive packet loss, resizing, rotation, re-encoding, and/or the like.

At “3,” the first watermarking component may be configured to send the encoded video data 134 and/or the encoded audio data 136 over the media stream. For example, the first watermarking component 118(1) may send the encoded video data 134 to a server 104 associated with the network-based communication system 106 via a first encrypted video stream 114(1) connecting the first user device 110(1) to the network-based communication system 106. Additionally, or alternatively, the first watermarking component 118(1) may send the encoded audio data 136 to the server 104 via a first encrypted audio stream 116(1) connecting the first user device 110(1) to the network-based communication system 106. That is, a second watermarking component 118(N) of the network-based communication system 106 may be configured to receive the video data 130 captured by the first camera 126 of the first user device 110(1) and/or the audio data 132 captured by the first microphone 128 of the first user device 110(1), where the video data 130 and/or audio data 132 are encoded with invisible and/or inaudible watermarks.

At “4,” the decoder 122 of the second watermarking component 118(N) may be configured to extract the invisible watermarks from the watermarked video data 134 and/or the watermarked audio data 136 to reveal a binary and/or hexadecimal message from the first user device 110(1) (e.g., the encoded pattern(s)). The network-based communication system 106 may utilize the registration information associated with the first user device 110(1) and stored in the certificate database 120 to determine one or more first public certificate(s) (e.g., a public key) associated with the first user device 110(1). For example, the network-based communication system 106 may utilize the serial number and/or PID associated with the first user device 110(1) to look up a first public certificate associated with the first camera 126 and/or a second public certificate associated with the first microphone 128.

At “5,” the second watermarking component 118(N) may then validate the encoded pattern(s) represented by the steganographic watermarks using the public certificate(s). That is, the second watermarking component 118(N) may be configured to validate the authenticity of the first encoded pattern associated with the video data 130 based on a first public certificate associated with the camera 126 of the first user device 110(1). Additionally, or alternatively, the second watermarking component 118(N) may be configured to validate the second encoded pattern associated with the audio data 132 based on a second public certificate associated with the microphone 128 of the first user device 110(1). The second watermarking component 118(N) may then validate the authenticity of the camera 126 and/or microphone 128 as capturing the video data 130 and/or audio data 132, and that the video data 130 and/or audio data 132 has not been modified since capture.

At “6,” once validated, the network-based communication system 106 may then send the authenticated video data 138(1)-(N) and/or the authenticated audio data 140(1)-(N) to the one or more second user devices 110(2)-(N) associated with the media stream. For example, the network-based communication system 106 may send the authenticated video data 138(1)-(N) via one or more second encrypted video streams 114(2)-(N) and/or the authenticated audio data 140(1)-(N) via one or more second encrypted audio stream 116(2)-(N) to respective second user devices 110(2)-(N) associated with the media stream. Additionally, following validation of the authenticity of the capture source camera 126 and/or microphone 128, the second watermarking component 118(N) may send a signal to the second user devices 110(2)-(N) indicating that the video data 130 and/or audio data 132 transmitted over the encrypted video stream(s) 114(1)-(N) and/or encrypted audio stream(s) 116(1)-(N) have been unmodified from the time of capture at the source by a validated camera 126 and/or microphone 128. This signal is illustrated in FIGS. 1 and 2 as a lock icon accompanying the authenticated video data 138 and/or authenticated audio data 140, respectively. In some examples, the signal may cause an icon to display on the screens of the second user device(s) 110(2)-(N) indicating the validation of authenticity of the capture source(s). Additionally, or alternatively, the signal may cause the second user devices 110(2)-(N) to output a sound, and/or display any other form of indication that the capture source(s) authenticity has been validated. This process may continuously run as the media stream persists, and if the authenticity of the capture source(s) 126, 128 cannot be validated at any point during the media stream, additional signal(s) may be sent to the second user devices 110(2)-(N) causing the icon (or other indication) to toggle on and/or off as needed.

While FIG. 1 is described with respect to a media stream configured as a multi-party conference stream, take, for example, the media stream being configured as a point-to-point stream, as described in more detail with respect to FIG. 2.

FIG. 2 illustrates a system-architecture diagram of an example environment 200 and flow for a computing resource network 102 hosting a network-based communication system 106 to validate the authenticity of capture source(s) of a first user device 110(1) and/or a second user device 110(N) transmitting video data 130 and/or audio data 132 in association with a media stream. In some examples, the example environment 200, and the components thereof, may substantially correspond to the example environment 100, and the components thereof, as illustrated in FIG. 1. As illustrated in FIG. 2, the media stream may be configured as a point-to-point stream comprising the first user device 110(1) configured with the first watermarking component 118(1) and a second user device 110(N) configured with a second watermarking component 118(N). In such an example, the network-based communication system 106 may be configured to host the encrypted video stream(s) 114(1)-(N) and/or encrypted audio stream(s) 116(1)-1(N) associated with the media stream, without validating the authenticity of the capture source. Additionally, or alternatively, the second watermarking component 118(N) of the second user device 110(N) may be configured to validate the authenticity of the capture source(s) 126, 128 of the first user device 110(1), for example.

Below is an example flow describing a second user device 110(N), associated with a media stream hosted by a network-based communication system 106, configured to validate the authenticity of capture source(s) 126(1), 128(2) of a first user device 110(1) streaming video data 130(1) and/or audio data 132(1) to the second user device 110(N) over encrypted video streams 114(1)-(N) and/or encrypted audio streams 116(1)-(N). While the following example describes the second user device 110(N) validating the authenticity of the capture source(s) 126, 128 of the first user device 110(1), the process(es) performed by the first user device 110(1) may be performed by the second user device 110(N) and the process(es) performed by the second user device 110(N) may be performed by the first user device 110(1). That is, the validation of authenticity of capture sources may be performed in both directions by the first user device 110(1) and/or the second user device 110(N), respectively.

At “1,” video data 130(1) and/or audio data 132(1) associated with the first user 108(1) may be captured by a first camera 126(1) and/or a first microphone 128(1) of the first user device 110(1) and sent to the first watermarking component 118(1) of the first user device 110(1). Additionally, or alternatively, private certificate(s) associated with the camera 126(1) and/or the microphone 128(1) (as illustrated in FIGS. 1 and 2 as the key icon accompanying the video data 130(1) and/or the audio data 132(1), respectively) of the first user device 110(1) may be transmitted to the first watermarking component 118(1) of the first user device 110(1). In some examples, the private certificate(s) may comprise a private key, an SUDI certificate, and/or the like. That is, the first watermarking component 118(1) may receive first video data 130(1) captured by a first camera 126(1) of the first user device 110(1) and/or first audio data 132(1) captured by a first microphone 128(1) of the first user device 110(1) in association with the media stream of the network-based communication system 106.

At “2,” the first watermarking component 118(1) receives the video data 130(1) and/or audio data 132(1), and a first encoder 124(1) of the first watermarking component 118(1) may be configured to encode the video data 130(1) and/or audio data 132(1) with one or more watermark(s). For example, the first user device 110(1) may generate a pattern used to determine at least a portion of the watermarks. In some examples, parameters for generating the pattern may be configured by the network-based communication system 106. Additionally, or alternatively, the pattern may be based on a random pattern generation, and/or based on a timestamp representing the time at which the video data 130(1) and/or audio data 132(1) was captured. The first watermarking component 110(1) may be configured to generate an encoded pattern by signing the pattern using the private certificate(s) received from the camera 126(1) and/or the microphone 128(1) of the first user device 110(1). For example, a first encoded pattern may be generated in association with the video data 130(1) and based at least in part on signing the pattern with a first private certificate associated with the camera 126(1) of the first user device 110(1). Additionally, or alternatively, a second encoded pattern may be generated in association with the audio data 132(1) and based at least in part on signing the pattern with the second private certificate associated with the microphone 128(1) of the first user device 110(1). Additionally, or alternatively, a single encoded pattern may be generated in association with both the video data 130(1) and the audio data 132(1) based on signing the pattern with both the first private certificate and the second private certificate. Once the encoded pattern(s) are determined, the encoder 124 of the first watermarking component may generate watermarked video data 134(1) (also referred to herein as encoded video data) and/or watermarked audio data 136(1) (also referred to herein as encoded audio data) based on encoding watermark(s) representing the encoded pattern(s) into the video data 130(1) and/or audio data 132(1).

Additionally, or alternatively, during the encoding of the steganographic watermarks into the video data 130(1) and/or audio data 132(1), the first watermarking component 118(1) of the first user device 110(1) may be configured to encode the public certificate(s) associated with the capture sources 126(1), 128(1), and the encoded pattern(s) generated by the first user device 110(1) into the video data 130(1) and/or audio data 132(1) as watermarks. That is, the public certificate(s) of the camera 126(1) and/or microphone 128(1) of the first user device 110(1) may be first encoded into the video data 130(1) and/or audio data 132(1) as first watermark(s) and the encoded pattern(s) may be encoded into the video data 130(1) and/or audio data 132(1) as second watermark(s).

Watermarks encoded into the video data 130(1) may be steganographic watermarks that are invisible to the human eye and only detectable by a specific neural network (e.g., the decoder 122(N) of a receiving watermarking component 118(N)). Additionally, or alternatively, watermarks encoded into the audio data 132(1) may be steganographic watermarks that are inaudible to the human car and only detectable by a specific neural network (e.g., the decoder 122(N) of a receiving watermarking component 118(N)). In some examples, the encoder 124(1) may be configured to encode both the first encoded pattern associated with the video data 130(1) and the second encoded pattern associated with the audio data 132(1) into the encoded video data 134(1) and sent over the encrypted video stream 114(1). That is, in some examples, only the video data 130(1) is encoded with watermarks comprising the encoded patterns utilized to validate the authenticity of both the video data 130(1) and the audio data 132(1). By encoding in this way, the watermarks cannot be removed, are not visible to the human eye, and are inaudible to the human car. Additionally, the watermarks are configured to survive packet loss, resizing, rotation, re-encoding, and/or the like.

At “3,” the first watermarking component may be configured to send the encoded video data 134(1) and/or the encoded audio data 136(1) over the media stream. For example, the first watermarking component 118(1) may send the encoded video data 134(1) to a server 104 associated with the network-based communication system 106 via a first encrypted video stream 114(1) connecting the first user device 110(1) to the network-based communication system 106. Additionally, or alternatively, the first watermarking component 118(1) may send the encoded audio data 136(1) to the server 104 via a first encrypted audio stream 116(1) connecting the first user device 110(1) to the network-based communication system 106. The network-based communication system 106 may send the watermarked video data 134(1) and/or the watermarked audio data 136(1) to the second user device 110(N) via a second encrypted video stream 114(N) and/or a second audio stream 116(N). That is, the network-based communication system 106 may be configured to facilitate end-to-end encryption of the media stream between the first user device 110(1) and the second user device 110(N).

At “4,” a second watermarking component 118(N) of the second user device 110(N) may be configured to receive the video data 130(1) captured by the first camera 126(1) of the first user device 110(1) and/or the audio data 132(1) captured by the first microphone 128(1) of the first user device 110(1), where the video data 130(1) and/or audio data 132(1) are encoded with invisible and/or inaudible watermarks. The second watermarking component 118(N) of the second user device may receive the encoded video data 134(1) and/or encoded audio data 136(1) and the decoder 122(N) thereof may extract the invisible and/or inaudible watermarks from the video data 130 and/or audio data 132. In examples where the public certificate(s) associated with the first user device 110(1) are encoded into the video data 130(1) and/or audio data 132(1) as watermarks, the second watermarking component 118(N) may be configured to extract the public certificate(s) from the watermarked video data 134(1) and/or the watermarked audio data 136(1) and use the public certificate(s) to validate the authenticity of the encoded pattern(s) that will be received throughout the remainder of the media stream. Additionally, or alternatively, the network-based communication system 106 may be configured to lookup the public certificate(s) associated with the first user device 110(1) according to techniques described herein, and may send the public certificate(s) to the second user device 110(N). The public certificate(s) may be leveraged by the second watermarking component 118(N) to validate the encoded pattern(s) represented by the watermark(s) so that the second user device 110(N) may validate the authenticity of the video data 130(1) and/or audio data 132(1) received from the first user device 110(1).

At “5,” upon validation, the second user device 110(N) may display an icon informing the second user 108(N) of the second device 110(N) that the video data 130(1) and/or audio data 132(1) has been unmodified since being captured by the first camera 126(1) and/or the first microphone 128(1) of the first user device.

While the above examples described with respect to FIGS. 1 and 2 describe validating the authenticity of video data and/or audio data captured by a camera and/or microphone of a first user device, the techniques described herein may be utilized to capture video data 130 and/or audio data 132 on a first user device 110(1), encoded with watermarks, and sent to a the network-based communication system 106 for storage and/or later broadcast, where the authenticity of the capture source(s) 126(1), 128(1) of both the video data 130(1) and/or the audio data 132(1) may be validated and indicated to second users 108(2)-(N) that view the media at a later time.

FIG. 3 illustrates a diagram 300 of an example mapping of binary data and/or hex data representing a signed signature associated with a user device to watermark symbols that are encoded into video data and representative of the signed signature. For example, the hex to symbol mapping 302 illustrates various characters (e.g., 0-9 and A-F) mapped to various symbols. While the hex to symbol mapping 302 includes the example characters and/or symbols, any number of characters could be leveraged and mapped to any number of symbols.

As previously described with respect to FIGS. 1 and 2, and encoder of a watermarking component may be configured to vary the invisible watermarks in the media (e.g., in the images that comprise a video stream), allowing for the in-band, steganographic encoding of binary and/or hex data representing a signed signature 304 into the media as watermark(s) 306. This data may then be leveraged to represent a signed signature 304 (also referred to herein as an encoded pattern) and/or a public certificate for capture device(s) (e.g., the camera or the microphone) of an endpoint of a media stream. Additionally, or alternatively, the decoder of a watermarking component may be configured as a second neural network configured to spot the signed signature 304 that was encoded into the media by the encoder. In some examples, the decoder may detect the pattern and verify whether it detects a watermark 306, suspects that the media contains a watermark 306, and/or finds that the media contains no watermark 306. By leveraging the AI-based watermarking technologies, watermarks 306 encoded in this way cannot be removed from the encoded media and they are not visible to the human eye. Additionally, such watermarks 306 encoded in this way are configured to survive packet loss, resizing, and/or re-encoding, meaning that the encoded watermarks can still be detected even if the media is screenshotted or edited, such as, for example, rotating or resizing of the image (e.g., rotating or cropping an image to resize the media for display on various recipient user device(s)).

That is, the signed signature 304 may be generated by a user device, and the encoder of a watermarking component of such a device may encode the signed signature into video data and/or audio data as a watermark 306. Additionally, or alternatively, the signed signature 304 associated with a first user device may be determined by a second user device by leveraging a decoder of a watermarking component of the second user device to extract the signed signature encoded as a watermark 306 and validate the signed signature 304 to validate the authenticity of the capture source(s) of the first user device.

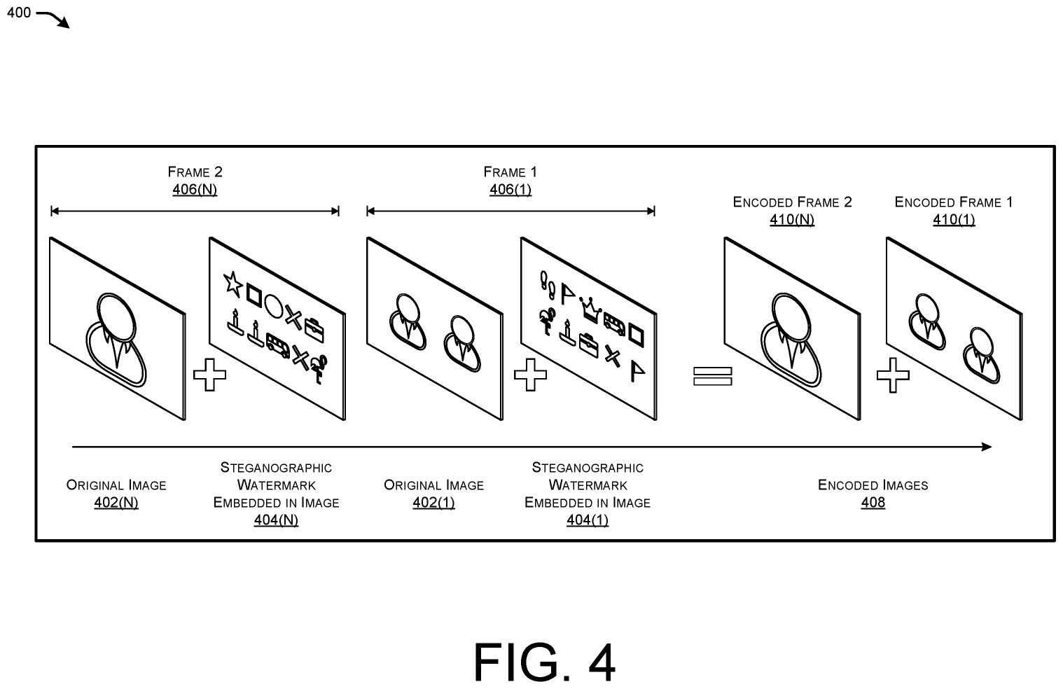

FIG. 4 illustrates a diagram of an example diagram 400 for encoding original image(s) 402(1)-(N) captured by a camera with steganographic watermarks embedded in the image(s) 404(1)-(N) of frame(s) 406(1)-(N) to generate encoded images 408 to send as encoded frame(s) 410(1)-(N) over a video stream in association with the network-based communication system, as described herein. As illustrated by FIG. 4, from a visible perspective, the encoded images 408 appear to the human eye the same as the original image(s) 402(1)-(N), even though they include the steganographic watermark embedded in the image(s) 404(1)-(N), which can then be extracted and decoded upon receipt of a decoder of a watermark component, as described herein.

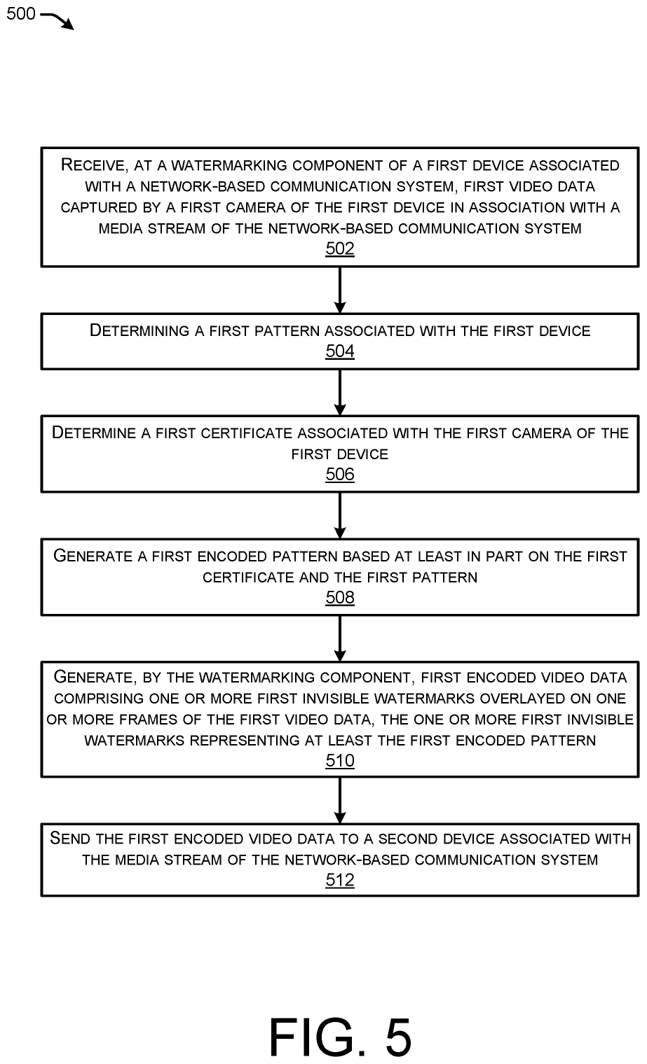

FIGS. 5-7 illustrate flow diagrams of example methods 500-700 and that illustrate aspects of the functions performed at least partly by the computing resource network 102 and/or by the respective components within as described in FIGS. 1 and 2. The logical operations described herein with respect to FIGS. 5-7 may be implemented (1) as a sequence of computer-implemented acts or program modules running on a computing system and/or (2) as interconnected machine logic circuits or circuit modules within the computing system. In some examples, the method(s) 500-700 may be performed by a system comprising one or more processors and one or more non-transitory computer-readable media storing computer-executable instructions that, when executed by the one or more processors, cause the one or more processors to perform the method(s) 500-700.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIGS. 5-7 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIG. 5 illustrates a flow diagram of an example method 500 for a device to encode invisible watermarks into video data captured by a camera of the device according to the techniques described herein. In some examples, the device and/or the camera may correspond to the user device(s) 110 and/or the camera(s) 126 as described with respect to FIGS. 1 and 2.

At 502, the method 500 includes receiving first video data captured by a first camera of a first device in association with a media stream of a network-based communication system. In some examples, the first video data may be received at a watermarking component of the first device. In some examples, the network-based communication system and/or the watermarking component may correspond to communication system 106 and/or the watermarking component(s) 118 as described with respect to FIGS. 1 and 2.

At 504, the method 500 includes determining a first pattern associated with the first device. In some examples, the pattern may be random and/or may be configured by a user of the first device. For example, the pattern may be configured as a timestamp representing the capture time of the video data.

At 506, the method 500 includes determining a first certificate associated with the first camera of the first device. In some examples, the first certificate may correspond to the certificate(s) as described and illustrated with respect to FIGS. 1 and 2 as the “key” icon accompanying the video data 130 and/or audio data 132.

At 508, the method 500 includes generating a first encoded pattern based at least in part on the first certificate and the first pattern. In some examples, the first encoded pattern may correspond to the signed signature 304 as described with respect to FIG. 3.

At 510, the method 500 includes generating, by the watermarking component, first encoded video data comprising one or more first invisible watermarks overlayed on one or more frames of the first video data. In some examples, the one or more first invisible watermarks may represent at least the first encoded pattern. Additionally, or alternatively, the one or more first invisible watermarks may correspond to the steganographic watermark embedded in image 404 as described with respect to FIG. 4. Additionally, or alternatively, the encoded video data may correspond to the watermarked video data 134 as described with respect to FIGS. 1 and 2. In some examples, an encoder of the watermarking component may be configured to generate the first encoded video data, such as, for example, the encoder 124 as described with respect to FIGS. 1 and 2.

At 512, the method 500 includes sending the first encoded video data to a second device associated with the media stream of the network-based communication system.

In some examples, the one or more first invisible watermarks may be configured to persist modifications made to the first encoded video data based at least in part on at least one of a first resizing of the first encoded video data from a first size to a second size, a second resizing of the first encoded video data from a first aspect ratio to a second aspect ratio, a rotation of the first encoded video data, and/or a cropping of the first encoded video data from the first size to a third size.

In some examples, the second device may be configured as a cloud-based server of the network-based communication system and/or the first encoded video data may be sent to the second device over a first encrypted video stream of the media stream.

In some examples, the second device may be further configured to authenticate the encoded video data prior to sending the encoded video data to a third device associated with the media stream over a second encrypted video stream of the media stream. Additionally, or alternatively, authenticating the encoded video data may comprise at least one of determining that the first video data was captured by the first device and/or determining that the first video data is unmodified since being captured by the first camera of the first device.

Additionally, or alternatively, the method 500 includes receiving, at the watermarking component of the first device, first audio data captured by a first microphone of the first device in association with the media stream. Additionally, or alternatively, the method 500 includes. Additionally, or alternatively, the method 500 includes determining a second certificate associated with the first microphone of the first device. Additionally, or alternatively, the method 500 includes generating a second encoded pattern based at least in part on the second certificate and the first pattern. Additionally, or alternatively, the method 500 includes generating, by the watermarking component, first encoded audio data comprising first inaudible watermarks overlayed on the first audio data. In some examples, the first inaudible watermarks representing the second encoded pattern. Additionally, or alternatively, the method 500 includes sending the first encoded audio data to the second device associated with the media stream of the network-based communication system.

In some examples, the first encoded video data may be sent to the second device over an encrypted video stream of the media stream and/or the first encoded audio data is sent to the second device over an encrypted audio stream of the media stream.

Additionally, or alternatively, the method 500 includes receiving, at the watermark component of the first device and from the media stream, second encoded video data comprising second invisible watermarks overlayed on second video data captured by a second camera of the second device. Additionally, or alternatively, the method 500 includes determining a second encoded pattern represented by the second invisible watermarks based at least in part on decoding the invisible watermark from the second encoded video data. Additionally, or alternatively, the method 500 includes determining a second certificate associated with the second device. Additionally, or alternatively, the method 500 includes determining whether the second video data has been modified since being captured by the camera of the second device based at least in part on validating the second encoded pattern using the second certificate. Additionally, or alternatively, the method 500 includes based at least in part on determining whether the second video data has been modified, at least one of causing the first device to display the second video data and a first icon indicating that the video data is unmodified since being captured by the second camera of the second device, causing the first device to display the second video data and a second icon indicating that the video data has been modified since being captured by the second camera of the second device, and/or causing the first device to refrain from displaying the second video data.

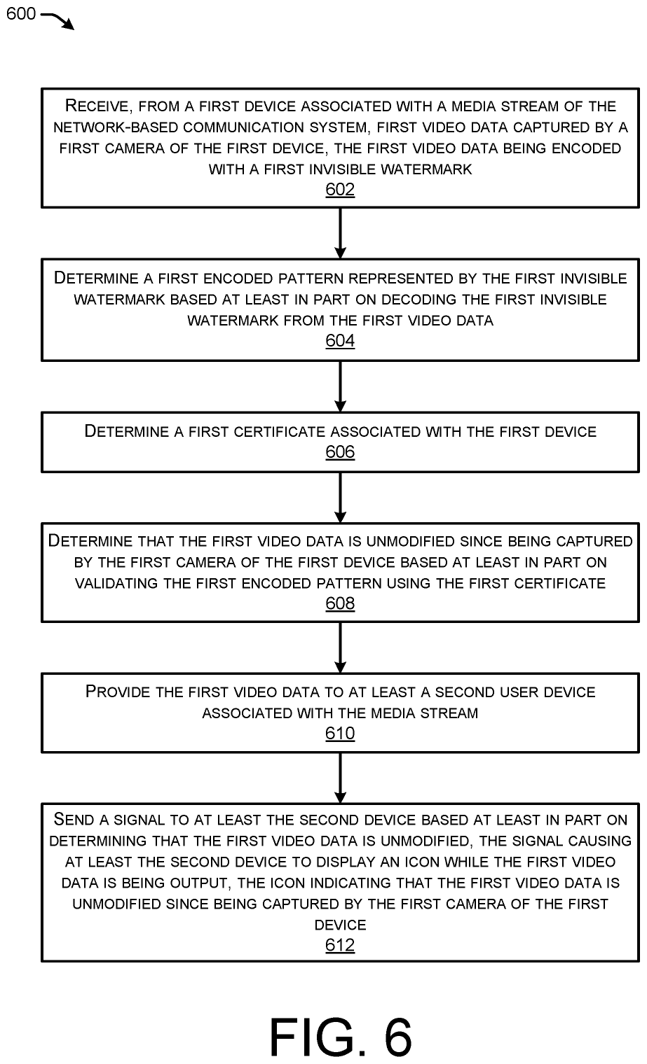

FIG. 6 illustrates a flow diagram of an example method 600 for a network-based communication system to decode invisible watermarks from video data captured by a camera of a device to validate the authenticity of the camera of the device according to the techniques described herein. In some examples, the network-based communication system, the camera, and/or the device may correspond to the communication system 106, the camera 126, and/or the user device 110 as described with respect to FIGS. 1 and 2.

At 602, the method 600 includes receiving, from a first device associated with a media stream of the network-based communication system, first video data captured by a first camera of the first device. In some examples, the first video data may be encoded with a first invisible watermark. Additionally, or alternatively, the first invisible watermark may correspond to the steganographic watermark embedded in image 404 as described with respect to FIG. 4.

At 604, the method 600 includes determining a first encoded pattern represented by the first invisible watermark based at least in part on decoding the first invisible watermark from the first video data. In some examples, the first encoded pattern may correspond to the signed signature 304 as described with respect to FIG. 3. In some examples, a decoder of the watermark component may be configured to decode the first invisible watermark, such as, for example, the decoder 122 as described with respect to FIGS. 1 and 2.

At 606, the method 600 includes determining a first certificate associated with the first device. In some examples, the first certificate may correspond to the certificate(s) as described and illustrated with respect to FIGS. 1 and 2 as the “key” icon accompanying the video data 130 and/or audio data 132.

At 608, the method 600 includes determining that the first video data is unmodified since being captured by the first camera of the first device based at least in part on validating the first encoded pattern using the first certificate.

At 610, the method 600 includes providing the first video data to at least a second user device associated with the media stream.

At 612, the method 600 includes sending a signal to at least the second device based at least in part on determining that the first video data is unmodified. In some examples, the signal may cause at least the second device to display an icon while the first video data is being output. Additionally, or alternatively, the icon may indicate that the first video data is unmodified since being captured by the first camera of the first device.

In some examples, the signal is a first signal and the icon is a first icon. Additionally, or alternatively, the method 600 includes receiving, from the second device associated with the media stream of the network-based communication system, second video data captured by a second camera of the second device. In some examples, the second video data may be encoded with a second invisible watermark. Additionally, or alternatively, the method 600 includes determining a second encoded pattern represented by the second invisible watermark based at least in part on decoding the second invisible watermark from the second video data. Additionally, or alternatively, the method 600 includes determining a second certificate associated with the second device. Additionally, or alternatively, the method 600 includes determining whether the second video data has been modified since being captured by the second camera of the second device based at least in part on validating the second encoded pattern using the second certificate. Additionally, or alternatively, the method 600 includes providing the second video data to at least the first device associated with the media stream. Additionally, or alternatively, the method 600 includes based at least in part on determining whether the second video data has been modified since being captured by the second camera of the second device, at least one of sending the first signal to the first device, the first signal causing the first device to display the first icon while the second video data is being displayed, the first icon indicating that the second video data is unmodified since being captured by the second camera of the second device and/or sending a second signal to the first device, the second signal causing the first device to display a second icon while the second video data is being displayed, the second icon indicating that the second video data has been modified since being captured by the second camera of the second device.

In some examples, the first video data may be sent to the second device over a first encrypted video stream of the media stream and/or the second video data may be sent to the first device over a second encrypted video stream of the media stream.

In some examples, the first encoded pattern may be generated by the first device and based at least in part on a first timestamp at which the first video data was recorded and/or a first private key associated with the first camera of the first device and/or the second encoded pattern may be generated by the second device and based at least in part on a second timestamp at which the second video data was recorded and/or a second private key associated with the second camera of the second device.

Additionally, or alternatively, the method 600 includes determining the first certificate associated with the first device based at least in part on at least one of identifying the first certificate based at least in part on decoding the first invisible watermark from the first video data and/or identifying the first certificate in a datastore associated with the network-based communication system.

Additionally, or alternatively, the method 600 includes receiving, from the first device associated with the media stream of the network-based communication system, first audio data captured by a first microphone of the first device. In some examples, the first audio data may be encoded with a first inaudible watermark. Additionally, or alternatively, the method 600 includes determining a second encoded pattern represented by the first inaudible watermark based at least in part on decoding the first inaudible watermark from the first audio data. Additionally, or alternatively, the method 600 includes determining a second certificate associated with the first microphone of the first device. Additionally, or alternatively, the method 600 includes determining whether the first audio data has been modified since being captured by the first microphone of the first device based at least in part on authenticating the second encoded pattern using the second certificate. Additionally, or alternatively, the method 600 includes providing the first audio data to at least the second device associated with the media stream. Additionally, or alternatively, the method 600 includes sending the signal to at least the second device based at least in part on determining that the first audio data is unmodified since being captured by the first microphone of the first device.

Additionally, or alternatively, the method 600 includes providing the first video data to at least the second device over a first encrypted video stream of the media stream. Additionally, or alternatively, the method 600 includes providing the first audio data to at least the first device over a first encrypted audio stream of the media stream.

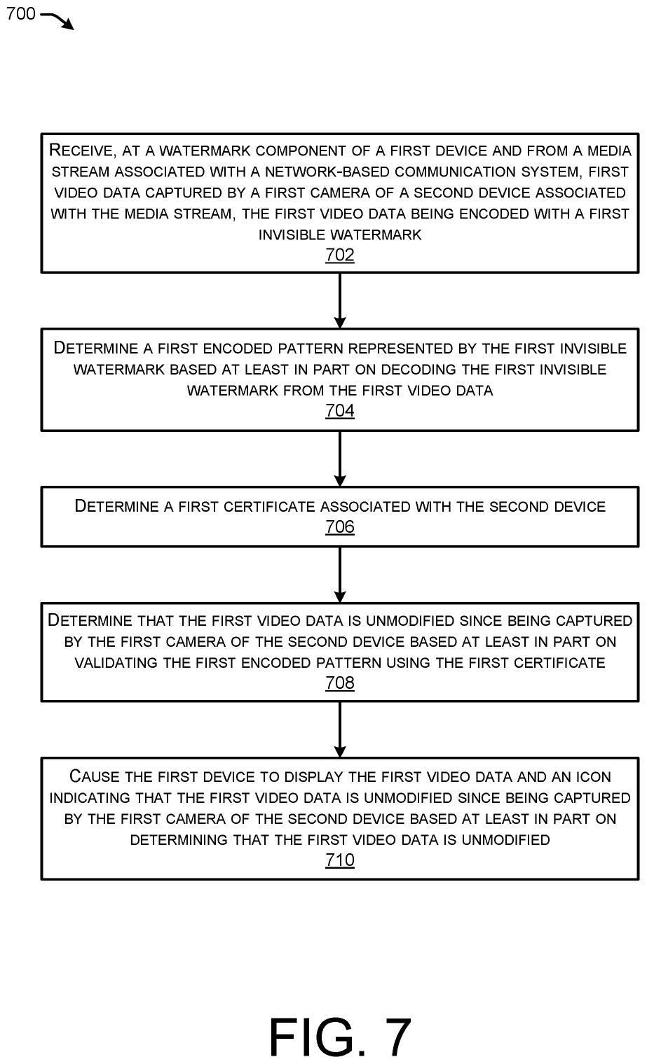

FIG. 7 illustrates a flow diagram of an example method 700 for a first device to decode invisible watermarks from video data captured by a camera of a second device to validate the authenticity of the camera of the second device according to the techniques described herein. In some examples, the first device, the camera, and the second device may correspond to the user device 110(N), the camera 126(N), and/or the user device 110(1) as described with respect to FIG. 2.

At 702, the method 700 includes receiving, at a watermark component of a first device and from a media stream associated with a network-based communication system, first video data captured by a first camera of a second device associated with the media stream. In some examples, the first video data may be encoded with a first invisible watermark. Additionally, or alternatively, the first invisible watermark may correspond to the steganographic watermark embedded in image 404 as described with respect to FIG. 4.

At 704, the method 700 includes determining a first encoded pattern represented by the first invisible watermark based at least in part on decoding the first invisible watermark from the first video data. In some examples, the first encoded pattern may correspond to the signed signature 304 as described with respect to FIG. 3. In some examples, a decoder of the watermark component may be configured to decode the first invisible watermark, such as, for example, the decoder 122 as described with respect to FIGS. 1 and 2.

At 706, the method 700 includes determining a first certificate associated with the second device. In some examples, the first certificate may correspond to the certificate(s) as described and illustrated with respect to FIGS. 1 and 2 as the “key” icon accompanying the video data 130 and/or audio data 132.

At 708, the method 700 includes determining that the first video data is unmodified since being captured by the first camera of the second device based at least in part on validating the first encoded pattern using the first certificate.

At 710, the method 700 includes causing the first device to display the first video data and/or an icon indicating that the first video data is unmodified since being captured by the first camera of the second device based at least in part on determining that the first video data is unmodified.

Additionally, or alternatively, the method 700 includes receiving a signal from the network-based communication system, the signal indicating that the first video data has been authenticated by the network-based communication system as being unmodified since being captured by the first camera of the second device. Additionally, or alternatively, the method 700 includes causing the first device to display the first video data and the icon based at least in part on receiving the signal.

Additionally, or alternatively, the method 700 includes determining the first certificate associated with the second device based at least in part on at least one of identifying the first certificate based at least in part on decoding the first invisible watermark from the first video data, identifying the first certificate in a datastore associated with the first device comprising certificates of devices associated with the network-based communication system, and/or receiving, at the watermarking component and from the network-based communication system, the first certificate.

Additionally, or alternatively, the method 700 includes receiving, at the watermarking component of the first device, second video data captured by a second camera of the first device in association with the media stream of the network-based communication system. Additionally, or alternatively, the method 700 includes determining a second pattern associated with the first device. Additionally, or alternatively, the method 700 includes determining a second certificate associated with the second camera of the first device. Additionally, or alternatively, the method 700 includes generating a second encoded pattern based at least in part on the second certificate and the second pattern. Additionally, or alternatively, the method 700 includes generating, by the watermarking component, first encoded video data comprising at least a second invisible watermark overlayed on one or more frames of the second video data. In some examples, the second invisible watermark may represent at least the second encoded pattern. Additionally, or alternatively, the method 700 includes providing the first encoded video data to the second device via the media stream associated with the network-based communication system.

Additionally, or alternatively, the method 700 includes receiving, at the watermark component of the first device and from the media stream associated with the network-based communication system, first audio data captured by a first microphone of the second device associated with the media stream. In some examples, the first audio data may be encoded with a first inaudible watermark. Additionally, or alternatively, the method 700 includes determining a second encoded pattern represented by the first inaudible watermark based at least in part on decoding the first inaudible watermark from the first audio data. Additionally, or alternatively, the method 700 includes Additionally, or alternatively, the method 700 includes determining a second certificate associated with the second device. Additionally, or alternatively, the method 700 includes determining that the first audio data is unmodified since being captured by the first microphone of the second device based at least in part on authenticating the second encoded pattern using the second certificate. Additionally, or alternatively, the method 700 includes causing the first device to output the first audio data and display the icon indicating that the first audio data is unmodified since being captured by the first microphone of the second device based at least in part on determining that the first audio data is unmodified.

Additionally, or alternatively, the method 700 includes receiving, at the watermarking component of the first device, first audio data captured by a first microphone of the first device in association with the media stream of the network-based communication system. Additionally, or alternatively, the method 700 includes determining a second pattern associated with the first device. Additionally, or alternatively, the method 700 includes determining a second certificate associated with the first microphone of the first device. Additionally, or alternatively, the method 700 includes generating a second encoded pattern based at least in part on the second certificate and the second pattern. Additionally, or alternatively, the method 700 includes generating, by the watermarking component, first encoded audio data comprising at least a first inaudible watermark overlayed on the first audio data, the first inaudible watermark representing at least the second encoded pattern. Additionally, or alternatively, the method 700 includes providing the first encoded audio data to the second device via the media stream associated with the network-based communication system.

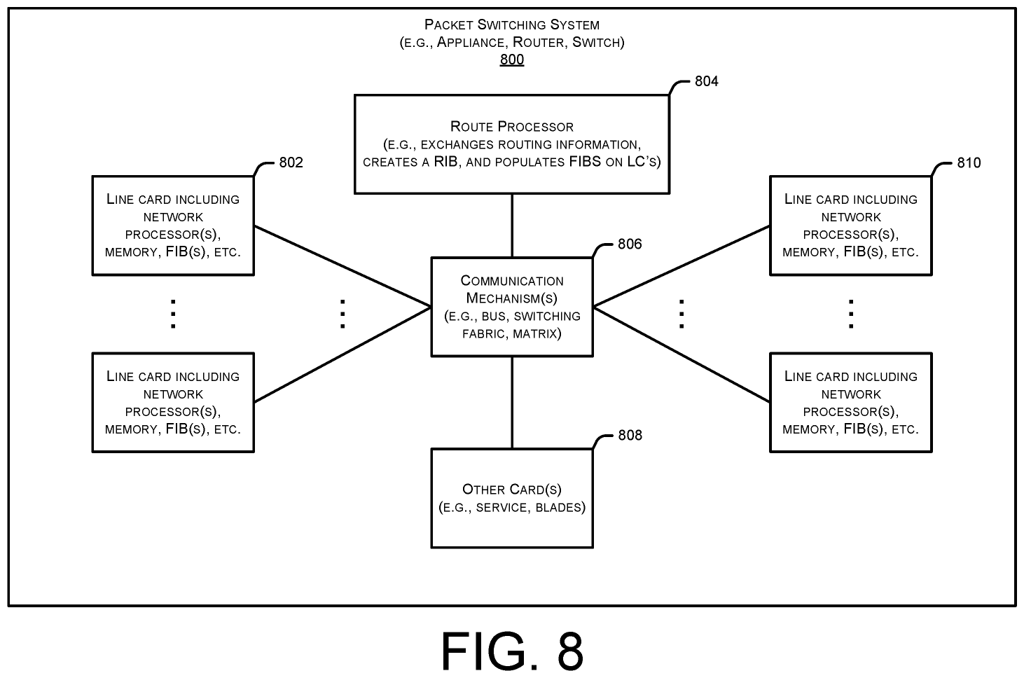

FIG. 8 illustrates a block diagram illustrating an example packet switching device (or system) 800 that can be utilized to implement various aspects of the technologies disclosed herein. In some examples, packet switching device(s) 800 may be employed in various networks, such as, for example, the computing resource network 102 as described with respect to FIGS. 1 and 2, respectively.

In some examples, a packet switching device 800 may comprise multiple line card(s) 802, 810, each with one or more network interfaces for sending and receiving packets over communications links (e.g., possibly part of a link aggregation group). The packet switching device 800 may also have a control plane with one or more processing elements 804 for managing the control plane and/or control plane processing of packets associated with forwarding of packets in a network. The packet switching device 800 may also include other cards 808 (e.g., service cards, blades) which include processing elements that are used to process (e.g., forward/send, drop, manipulate, change, modify, receive, create, duplicate, apply a service) packets associated with forwarding of packets in a network. The packet switching device 800 may comprise hardware-based communication mechanism 806 (e.g., bus, switching fabric, and/or matrix, etc.) for allowing its different entities 802, 804, 808 and 810 to communicate. Line card(s) 802, 810 may typically perform the actions of being both an ingress and/or an egress line card 802, 810, in regard to multiple other particular packets and/or packet streams being received by, or sent from, packet switching device 800.

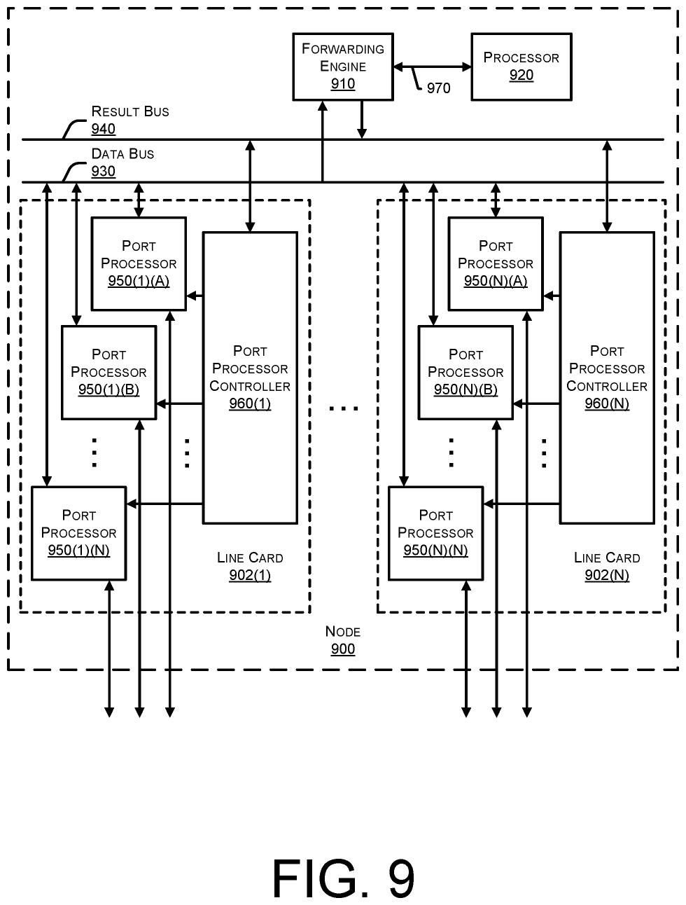

FIG. 9 illustrates a block diagram illustrating certain components of an example node 900 that can be utilized to implement various aspects of the technologies disclosed herein. In some examples, node(s) 900 may be employed in various networks, such as, for example, the computing resource network 102 as described with respect to FIGS. 1 and 2, respectively.

In some examples, node 900 may include any number of line cards 902 (e.g., line cards 902(1)-(N), where N may be any integer greater than 1) that are communicatively coupled to a forwarding engine 910 (also referred to as a packet forwarder) and/or a processor 920 via a data bus 930 and/or a result bus 940. Line cards 902(1)-(N) may include any number of port processors 950(1)(A)-(N)(N) which are controlled by port processor controllers 960(1)-(N), where N may be any integer greater than 1. Additionally, or alternatively, forwarding engine 910 and/or processor 920 are not only coupled to one another via the data bus 930 and the result bus 940, but may also communicatively coupled to one another by a communications link 970.

The processors (e.g., the port processor(s) 950 and/or the port processor controller(s) 960) of each line card 902 may be mounted on a single printed circuit board. When a packet or packet and header are received, the packet or packet and header may be identified and analyzed by node 900 (also referred to herein as a router) in the following manner. Upon receipt, a packet (or some or all of its control information) or packet and header may be sent from one of port processor(s) 950(1)(A)-(N)(N) at which the packet or packet and header was received and to one or more of those devices coupled to the data bus 930 (e.g., others of the port processor(s) 950(1)(A)-(N)(N), the forwarding engine 910 and/or the processor 920). Handling of the packet or packet and header may be determined, for example, by the forwarding engine 910. For example, the forwarding engine 910 may determine that the packet or packet and header should be forwarded to one or more of port processors 950(1)(A)-(N)(N). This may be accomplished by indicating to corresponding one(s) of port processor controllers 960(1)-(N) that the copy of the packet or packet and header held in the given one(s) of port processor(s) 950(1)(A)-(N)(N) should be forwarded to the appropriate one of port processor(s) 950(1)(A)-(N)(N). Additionally, or alternatively, once a packet or packet and header has been identified for processing, the forwarding engine 910, the processor 920, and/or the like may be used to process the packet or packet and header in some manner and/or maty add packet security information in order to secure the packet. On a node 900 sourcing such a packet or packet and header, this processing may include, for example, encryption of some or all of the packet's or packet and header's information, the addition of a digital signature, and/or some other information and/or processing capable of securing the packet or packet and header. On a node 900 receiving such a processed packet or packet and header, the corresponding process may be performed to recover or validate the packet's or packet and header's information that has been secured.

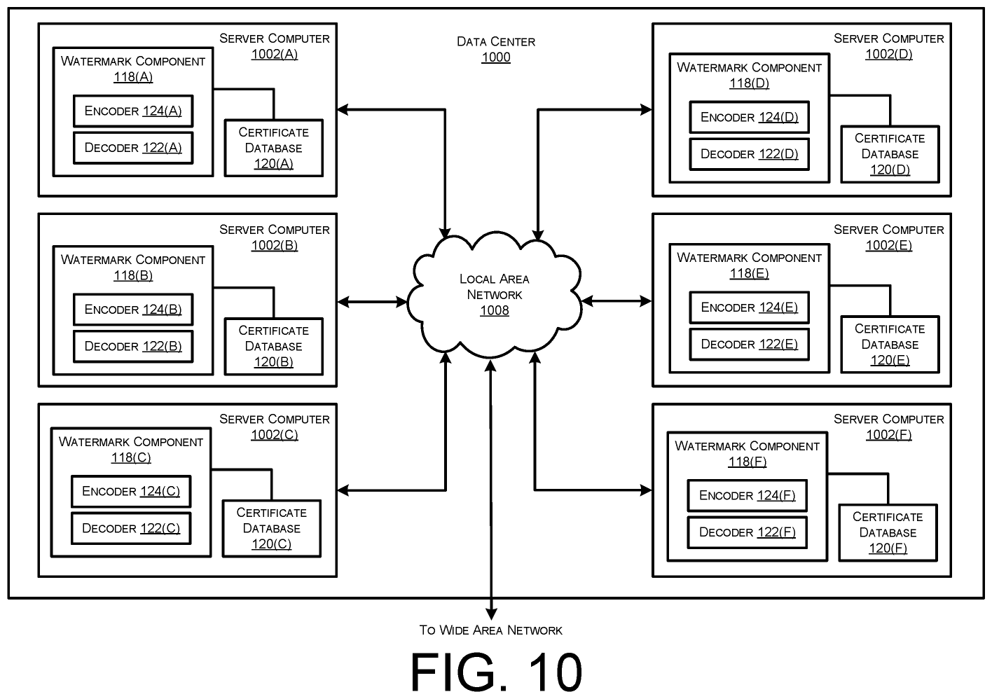

FIG. 10 is a computing system diagram illustrating a configuration for a data center 1000 that can be utilized to implement aspects of the technologies disclosed herein. The example data center 1000 shown in FIG. 10 includes several server computers 1002A-1002E (which might be referred to herein singularly as “a server computer 1002” or in the plural as “the server computers 1002”) for providing computing resources. In some examples, the server computers 1002 may include, or correspond to, the servers associated with the site (or data center) 104, the packet switching system 800, and/or the node 900 described herein with respect to FIGS. 1, 8 and 9, respectively.

The server computers 1002 can be standard tower, rack-mount, or blade server computers configured appropriately for providing the computing resources described herein. As mentioned above, the computing resources provided by the computing resource network 102 can be data processing resources such as VM instances or hardware computing systems, database clusters, computing clusters, storage clusters, data storage resources, database resources, networking resources, and others. Some of the servers 1002 can also be configured to execute a resource manager capable of instantiating and/or managing the computing resources. In the case of VM instances, for example, the resource manager can be a hypervisor or another type of program configured to enable the execution of multiple VM instances on a single server computer 1002. Server computers 1002 in the data center 1000 can also be configured to provide network services and other types of services.

In the example data center 1000 shown in FIG. 10, an appropriate LAN 1008 is also utilized to interconnect the server computers 1002A-1002E. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 1000, between each of the server computers 1002A-1002E in each data center 1000, and, potentially, between computing resources in each of the server computers 1002. It should be appreciated that the configuration of the data center 1000 described with reference to FIG. 10 is merely illustrative and that other implementations can be utilized.

In some examples, the server computers 1002 may each execute a watermark component 118 comprising an encoder 124 and/or a decoder 122. Additionally, or alternatively, the server computers 1002 may each store a certificate database 120.

In some instances, the computing resource network 102 may provide computing resources, like application containers, VM instances, and storage, on a permanent or an as-needed basis. Among other types of functionality, the computing resources provided by the computing resource network 102 may be utilized to implement the various services described above. The computing resources provided by the computing resource network 102 can include various types of computing resources, such as data processing resources like application containers and VM instances, data storage resources, networking resources, data communication resources, network services, and the like.

Each type of computing resource provided by the computing resource network 102 can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The computing resource network 102 can also be configured to provide other types of computing resources not mentioned specifically herein.

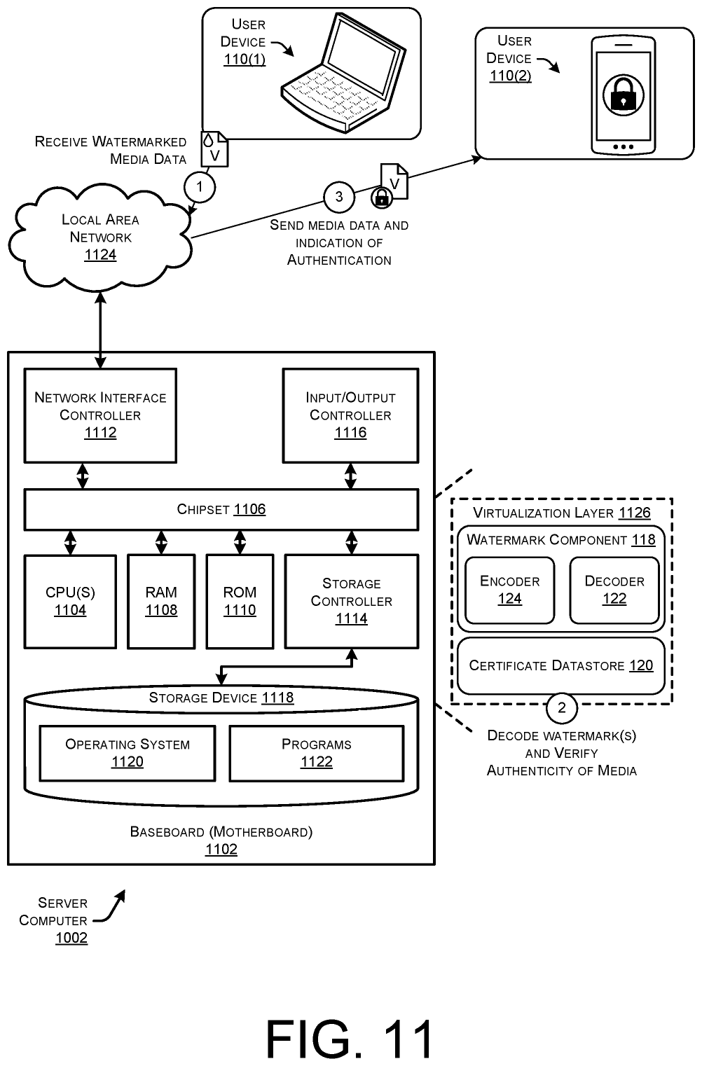

The computing resources provided by the computing resource network 102 may be enabled in one embodiment by one or more data centers 1000 (which might be referred to herein singularly as “a data center 1000” or in the plural as “the data centers 1000”). The data centers 1000 are facilities utilized to house and operate computer systems and associated components. The data centers 1000 typically include redundant and backup power, communications, cooling, and security systems. The data centers 1000 can also be located in geographically disparate locations. One illustrative embodiment for a data center 1000 that can be utilized to implement the technologies disclosed herein will be described below with regard to FIG. 11.

FIG. 11 shows an example computer architecture for a computing device (or network routing device) 1002 capable of executing program components for implementing the functionality described above. The computer architecture shown in FIG. 11 illustrates a conventional server computer, workstation, desktop computer, laptop, tablet, network appliance, e-reader, smartphone, or other computing device, and can be utilized to execute any of the software components presented herein. The computing device 1002 may, in some examples, correspond to a physical server of a data center 104, the packet switching system 800, and/or the node 900 described herein with respect to FIGS. 1, 8, and 9, respectively.

The computing device 1002 includes a baseboard 1102, or “motherboard,” which is a printed circuit board to which a multitude of components or devices can be connected by way of a system bus or other electrical communication paths. In one illustrative configuration, one or more central processing units (“CPUs”) 1104 operate in conjunction with a chipset 1106. The CPUs 1104 can be standard programmable processors that perform arithmetic and logical operations necessary for the operation of the computing device 1002.

The CPUs 1104 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 1106 provides an interface between the CPUs 1104 and the remainder of the components and devices on the baseboard 1102. The chipset 1106 can provide an interface to a RAM 1108, used as the main memory in the computing device 1002. The chipset 1106 can further provide an interface to a computer-readable storage medium such as a read-only memory (“ROM”) 1110 or non-volatile RAM (“NVRAM”) for storing basic routines that help to startup the computing device 1002 and to transfer information between the various components and devices. The ROM 1110 or NVRAM can also store other software components necessary for the operation of the computing device 1002 in accordance with the configurations described herein.

The computing device 1002 can operate in a networked environment using logical connections to remote computing devices and computer systems through a network, such as the network 1124 (or 1008). The chipset 1106 can include functionality for providing network connectivity through a NIC 1112, such as a gigabit Ethernet adapter. The NIC 1112 is capable of connecting the computing device 1002 to other computing devices over the network 1124. It should be appreciated that multiple NICs 1112 can be present in the computing device 1002, connecting the computer to other types of networks and remote computer systems.

The computing device 1002 can be connected to a storage device 1118 that provides non-volatile storage for the computing device 1002. The storage device 1118 can store an operating system 1120, programs 1122, and data, which have been described in greater detail herein. The storage device 1118 can be connected to the computing device 1002 through a storage controller 1114 connected to the chipset 1106. The storage device 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 1002 can store data on the storage device 1118 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 1118 is characterized as primary or secondary storage, and the like.

For example, the computing device 1002 can store information to the storage device 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1002 can further read information from the storage device 1118 by detecting the physical states or characteristics of one or more particular locations within the physical storage units.

In addition to the mass storage device 1118 described above, the computing device 1002 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 1002. In some examples, the operations performed by the computing resource network 102, and or any components included therein, may be supported by one or more devices similar to computing device 1002. Stated otherwise, some or all of the operations performed by the computing resource network 102, and or any components included therein, may be performed by one or more computing device 1002 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 1118 can store an operating system 1120 utilized to control the operation of the computing device 1002. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 1118 can store other system or application programs and data utilized by the computing device 1002.

In one embodiment, the storage device 1118 or other computer-readable storage media is encoded with computer-executable instructions which, when loaded into the computing device 1002, transform the computer from a general-purpose computing system into a special-purpose computer capable of implementing the embodiments described herein. These computer-executable instructions transform the computing device 1002 by specifying how the CPUs 1104 transition between states, as described above. According to one embodiment, the computing device 1002 has access to computer-readable storage media storing computer-executable instructions which, when executed by the computing device 1002, perform the various processes described above with regard to FIGS. 1, 2, and 5-7. The computing device 1002 can also include computer-readable storage media having instructions stored thereupon for performing any of the other computer-implemented operations described herein.

The computing device 1002 can also include one or more input/output controllers 1116 for receiving and processing input from a number of input devices, such as a keyboard, a mouse, a touchpad, a touch screen, an electronic stylus, or other type of input device. Similarly, an input/output controller 1116 can provide output to a display, such as a computer monitor, a flat-panel display, a digital projector, a printer, or other type of output device. It will be appreciated that the computing device 1002 might not include all of the components shown in FIG. 11, can include other components that are not explicitly shown in FIG. 11, or might utilize an architecture completely different than that shown in FIG. 11.

The server computer 1002 may support a virtualization layer 1126, such as one or more components associated with the computing resource network 102 and/or the network-based communication system 106, such as, for example, the watermark component 118 and/or the certificate datastore 120. The watermark component 118 may be configured to receive watermarked media data from a first user device 110(1), decode the watermarks and validate the authenticity of the media, and second the media data and an indication of authentication of the media data to a second user device 110(2), according to the techniques described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, at a watermarking component of a first device associated with a network-based communication system, first video data captured by a first camera of the first device in association with a media stream of the network-based communication system;
determining a first pattern associated with the first device;
determining a first certificate associated with the first camera of the first device;
generating a first encoded pattern based at least in part on the first certificate and the first pattern;
generating, by the watermarking component, first encoded video data comprising one or more first invisible watermarks overlayed on one or more frames of the first video data, the one or more first invisible watermarks representing at least the first encoded pattern; and
sending the first encoded video data to a second device associated with the media stream of the network-based communication system.

2. The method of claim 1, wherein the one or more first invisible watermarks are configured to persist modifications made to the first encoded video data based at least in part on at least one of:
a first resizing of the first encoded video data from a first size to a second size;
a second resizing of the first encoded video data from a first aspect ratio to a second aspect ratio;
a rotation of the first encoded video data; or
a cropping of the first encoded video data from the first size to a third size.

3. The method of claim 1, wherein the second device is configured as a cloud-based server of the network-based communication system and the first encoded video data is sent to the second device over a first encrypted video stream of the media stream.

4. The method of claim 3, wherein the second device is further configured to authenticate the encoded video data prior to sending the encoded video data to a third device associated with the media stream over a second encrypted video stream of the media stream, wherein authenticating the encoded video data comprises at least one of:
determining that the first video data was captured by the first device; and
determining that the first video data is unmodified since being captured by the first camera of the first device.

5. The method of claim 1, further comprising:
receiving, at the watermarking component of the first device, first audio data captured by a first microphone of the first device in association with the media stream;
determining a second certificate associated with the first microphone of the first device;
generating a second encoded pattern based at least in part on the second certificate and the first pattern;
generating, by the watermarking component, first encoded audio data comprising first inaudible watermarks overlayed on the first audio data, the first inaudible watermarks representing the second encoded pattern; and
sending the first encoded audio data to the second device associated with the media stream of the network-based communication system.

6. The method of claim 5, wherein:
the first encoded video data is sent to the second device over an encrypted video stream of the media stream; and
the first encoded audio data is sent to the second device over an encrypted audio stream of the media stream.

7. The method of claim 1, further comprising:
receiving, at the watermark component of the first device and from the media stream, second encoded video data comprising second invisible watermarks overlayed on second video data captured by a second camera of the second device;
determining a second encoded pattern represented by the second invisible watermarks based at least in part on decoding the invisible watermark from the second encoded video data;
determining a second certificate associated with the second device;
determining whether the second video data has been modified since being captured by the camera of the second device based at least in part on validating the second encoded pattern using the second certificate; and
based at least in part on determining whether the second video data has been modified, at least one of:
causing the first device to display the second video data and a first icon indicating that the video data is unmodified since being captured by the second camera of the second device;
causing the first device to display the second video data and a second icon indicating that the video data has been modified since being captured by the second camera of the second device; or
causing the first device to refrain from displaying the second video data.

8. A network-based communication system comprising:
one or more processors; and
one or more computer-readable media storing computer-executable instructions that, when executed by the one or more processors, cause the one or more processors to perform operations comprising:
receiving, from a first device associated with a media stream of the network-based communication system, first video data captured by a first camera of the first device, the first video data being encoded with a first invisible watermark;
determining a first encoded pattern represented by the first invisible watermark based at least in part on decoding the first invisible watermark from the first video data;
determining a first certificate associated with the first device;
determining that the first video data is unmodified since being captured by the first camera of the first device based at least in part on validating the first encoded pattern using the first certificate;
providing the first video data to at least a second user device associated with the media stream; and
sending a signal to at least the second device based at least in part on determining that the first video data is unmodified, the signal causing at least the second device to display an icon while the first video data is being output, the icon indicating that the first video data is unmodified since being captured by the first camera of the first device.

9. The network-based communication system of claim 8, wherein the signal is a first signal and the icon is a first icon, and the operations further comprising:
receiving, from the second device associated with the media stream of the network-based communication system, second video data captured by a second camera of the second device, the second video data being encoded with a second invisible watermark;
determining a second encoded pattern represented by the second invisible watermark based at least in part on decoding the second invisible watermark from the second video data;
determining a second certificate associated with the second device;
determining whether the second video data has been modified since being captured by the second camera of the second device based at least in part on validating the second encoded pattern using the second certificate;
providing the second video data to at least the first device associated with the media stream; and
based at least in part on determining whether the second video data has been modified since being captured by the second camera of the second device, at least one of:
sending the first signal to the first device, the first signal causing the first device to display the first icon while the second video data is being displayed, the first icon indicating that the second video data is unmodified since being captured by the second camera of the second device; or
sending a second signal to the first device, the second signal causing the first device to display a second icon while the second video data is being displayed, the second icon indicating that the second video data has been modified since being captured by the second camera of the second device.

10. The network-based communication system of claim 9, wherein:
the first video data is sent to the second device over a first encrypted video stream of the media stream; and
the second video data is sent to the first device over a second encrypted video stream of the media stream.

11. The network-based communication system of claim 9, wherein:
the first encoded pattern is generated by the first device and based at least in part on a first timestamp at which the first video data was recorded and a first private key associated with the first camera of the first device; and
the second encoded pattern is generated by the second device and based at least in part on a second timestamp at which the second video data was recorded and a second private key associated with the second camera of the second device.

12. The network-based communication system of claim 8, the operations further comprising determining the first certificate associated with the first device based at least in part on at least one of:
identifying the first certificate based at least in part on decoding the first invisible watermark from the first video data; or
identifying the first certificate in a datastore associated with the network-based communication system.

13. The network-based communication system of claim 8, the operations further comprising:
receiving, from the first device associated with the media stream of the network-based communication system, first audio data captured by a first microphone of the first device, the first audio data being encoded with a first inaudible watermark;
determining a second encoded pattern represented by the first inaudible watermark based at least in part on decoding the first inaudible watermark from the first audio data;
determining a second certificate associated with the first microphone of the first device;
determining whether the first audio data has been modified since being captured by the first microphone of the first device based at least in part on authenticating the second encoded pattern using the second certificate;
providing the first audio data to at least the second device associated with the media stream; and
sending the signal to at least the second device based at least in part on determining that the first audio data is unmodified since being captured by the first microphone of the first device.

14. The network-based communication system of claim 13, the operations further comprising:
providing the first video data to at least the second device over a first encrypted video stream of the media stream; and
providing the first audio data to at least the first device over a first encrypted audio stream of the media stream.

15. A method comprising:
receiving, at a watermark component of a first device and from a media stream associated with a network-based communication system, first video data captured by a first camera of a second device associated with the media stream, the first video data being encoded with a first invisible watermark;
determining a first encoded pattern represented by the first invisible watermark based at least in part on decoding the first invisible watermark from the first video data;
determining a first certificate associated with the second device;
determining that the first video data is unmodified since being captured by the first camera of the second device based at least in part on validating the first encoded pattern using the first certificate; and
causing the first device to display the first video data and an icon indicating that the first video data is unmodified since being captured by the first camera of the second device based at least in part on determining that the first video data is unmodified.

16. The method of claim 15, further comprising:
receiving a signal from the network-based communication system, the signal indicating that the first video data has been authenticated by the network-based communication system as being unmodified since being captured by the first camera of the second device; and
causing the first device to display the first video data and the icon based at least in part on receiving the signal.

17. The method of claim 15, further comprising determining the first certificate associated with the second device based at least in part on at least one of:
identifying the first certificate based at least in part on decoding the first invisible watermark from the first video data;
identifying the first certificate in a datastore associated with the first device, the datastore comprising certificates of devices associated with the network-based communication system; or
receiving, at the watermarking component and from the network-based communication system, the first certificate.

18. The method of claim 15, further comprising:
receiving, at the watermarking component of the first device, second video data captured by a second camera of the first device in association with the media stream of the network-based communication system;
determining a second pattern associated with the first device;
determining a second certificate associated with the second camera of the first device;
generating a second encoded pattern based at least in part on the second certificate and the second pattern;
generating, by the watermarking component, first encoded video data comprising at least a second invisible watermark overlayed on one or more frames of the second video data, the second invisible watermark representing at least the second encoded pattern; and
providing the first encoded video data to the second device via the media stream associated with the network-based communication system.

19. The method of claim 15, further comprising:
receiving, at the watermark component of the first device and from the media stream associated with the network-based communication system, first audio data captured by a first microphone of the second device associated with the media stream, the first audio data being encoded with a first inaudible watermark;
determining a second encoded pattern represented by the first inaudible watermark based at least in part on decoding the first inaudible watermark from the first audio data;
determining a second certificate associated with the second device;
determining that the first audio data is unmodified since being captured by the first microphone of the second device based at least in part on authenticating the second encoded pattern using the second certificate; and
causing the first device to output the first audio data and display the icon indicating that the first audio data is unmodified since being captured by the first microphone of the second device based at least in part on determining that the first audio data is unmodified.

20. The method of claim 15, further comprising:
receiving, at the watermarking component of the first device, first audio data captured by a first microphone of the first device in association with the media stream of the network-based communication system;
determining a second pattern associated with the first device;
determining a second certificate associated with the first microphone of the first device;
generating a second encoded pattern based at least in part on the second certificate and the second pattern;
generating, by the watermarking component, first encoded audio data comprising at least a first inaudible watermark overlayed on the first audio data, the first inaudible watermark representing at least the second encoded pattern; and
providing the first encoded audio data to the second device via the media stream associated with the network-based communication system.
